(19) United States
(12) Patent Application Publication
(10) Pub. No.: US 2010/0286357 A1
(43) Pub. Date: Nov. 11, 2010

(54) RESIN COMPOSITION FOR TONER AND METHOD FOR PREPARING RESIN COMPOSITION FOR TONER

(75) Inventors: Kenichi Matsumura, Yamaguchi (JP); Takashi Shinjo, Osaka (JP); Yoshihiro Inui, Shiga (JP); Kazuhiro Oomori, Shiga (JP); Masao Ikeda, Osaka (JP)

Correspondence Address: BUCHANAN, INGERSOLL & ROONEY PC, POST OFFICE BOX 1404, ALEXANDRIA, VA, 22313-1404, US

(73) Assignee: MITSUI CHEMICALS, INC., Tokyo (JP)

(21) Appl. No.: 12/097,921

(22) PCT Filed: Dec. 20, 2006
(86) PCT No.: PCT/JP2006/325428

§ 371 Date: Jul. 11, 2008

(30) Foreign Application Priority Data
Dec. 20, 2005 (JP) 2005-367043
Apr. 24, 2006 (JP) 2006-119533
Apr. 24, 2006 (JP) 2006-119535
Jul. 4, 2006 (JP) 2006-184679
Dec. 18, 2006 (JP) 2006-340127

(51) Int. Cl. C08G 18/12

(52) U.S. Cl. 528/59

(57) ABSTRACT

The present invention aims to provide a resin composition for toners which enables to obtain a toner having excellent low temperature fixability and high temperature offset resistance, and a toner. The resin composition for toners is obtained by reacting a mixture of a branched polyester (A) having a number average molecular weight of 2,000 to 7,000 and a hydroxyl value of 20 to 80, and a low molecular weight linear polyester (B) having a number average molecular weight of 2,000 to 5,000 and a hydroxyl number of 20 to 55, with an isocyanate compound containing two or more isocyanate groups in one molecule, which comprises a crosslinked structure of said branched polyester (A), a structure in which said branched polyester (A) and said low molecular weight linear polyester (B) are bonded by said isocyanate compound, and an unreacted portion of said low molecular weight linear polyester (B).

### TECHNICAL FIELD

The present invention relates to a resin composition for toners which enables to obtain a toner having excellent low temperature fixability and high temperature offset resistance, a toner, and a method for preparing a resin composition for toners.

### BACKGROUND ART

As a method of developing an electrostatic charge image in electrophotography or the like, a dry development process is frequently employed. In such a dry development process, usually, a toner is charged by friction with a so-called carrier such as an iron powder and glass beads, adheres on an electrostatic latent image on a photoconductor via an electric attractive force, and then is transferred onto a paper and fixed by a heat roller and the like, thereby establishing a permanent visual image.

As a fixation method, a heat roller method is frequently employed, in which a toner image on a sheet to be fixed is passed while being brought into contact under pressure with a surface of the heat fixation roller, the surface of which is made from a material having a toner releasing ability.

In the case of employing the heat fixation roller method, there is a need of a toner which can be fixed at a lower temperature for the purpose of improving economic efficiency such as power consumption as well as increasing the copying speed.

However, when it is intended to improve the low temperature fixability described above, there have been problems that, for example, an offset phenomenon that a part of the toner adheres on a surface of the heat fixation roller and subsequently re-transfers on a paper, or a blocking phenomenon that the toner is aggregated by the heat caused when respective resins go through various environments.

In a conventional polyester-based toner, usually tri- or higher-valent monomers have been copolymerized to form a chemical crosslinked structure in a polymer, and high temperature offset resistance has been maintained. However, in this method, since there existed polymers having a low molecular weight through crosslinked polymers having a high molecular weight, a broad molecular weight distribution is obtained, and thus it has been difficult to attain the compatibility between the high temperature offset resistance and the low temperature fixability.

Patent Document 1 proposes the use of, as a binder resin of a toner, a crystalline polyester resin including the units derived from terephthalic acid and a linear chained alkylene glycol having 2 to 6 carbon atoms, in an amount of 50 mol % or more, based on the total monomers used.

However, in this technology, since only the crystalline polyester resin is used, the temperature range for fixing is narrow, and it is difficult to maintain the high temperature offset resistance and the anti-blocking property without adversely affecting the low temperature fixability.

Patent Document 2 proposes the use of, as a binder resin of a toner, a non-crystalline polyester resin obtained by polymerization of tri- or higher-valent monomers, aromatic dicarboxylic acids, and aliphatic alcohols containing branched aliphatic alcohol in an amount of 50 mol % or more.

However, in this technology, since tri- or higher-valent monomers, dicarboxylic acids, diols, and the like are used, the molecular weight distribution of the resulting non-crystalline polyester is wide, and in particular, the low temperature fixability is not sufficient.

Further, Patent Document 3 discloses a method for preparing a binder resin having a predetermined range of gel fractions, including kneading and reacting a polyester to be formed by reacting containing dibasic carboxylic acids, diols, and triols, and having a hydroxyl value of 6 to 100, and a predetermined amount of isocyanate, using a kneading unit equipped with a screw. However, if kneading is conducted by a kneading unit equipped with a screw such as an extruding kneader, the polyester and the isocyanate are insufficiently crosslinked, leading to deterioration in the high temperature offset resistance of the resulting toner, and thus a desired toner performance cannot be attained.

Further, Patent Document 4 proposes the use of, as a binder resin of a toner, an urethane modified polyester that is obtained by reacting a mixture of a branched polyester having a hydroxyl value of 30 to 80 obtained by polymerization of dibasic carboxylic acids, diols, and tri- or higher polyhydric alcohols, and a low molecular weight linear polyester having a hydroxyl value of 5 or less obtained by polymerization of dibasic carboxylic acids, diols, and specific monocarboxylic acids, with a predetermined amount of diisocyanate.

Generally, when a mixture of a branched polyester and a low molecular weight linear polyester is reacted with isocyanate, the isocyanate reacts with OH groups of the low molecular weight linear polyester, in addition to the branched polyester, and as a result, the low temperature fixability exhibited by the low molecular weight linear polyester may be deteriorated. However, in this technology as disclosed herein, a low molecular weight linear polyester having COOH groups at most of its termini, the low molecular weight linear polyester and the isocyanate are substantially not reacted with each other, and thus it can be expected that low temperature fixability will be exhibited by the low molecular weight linear polyester.

However, in practice, there is a difference in viscosity between a crosslinked product of the branched polyester and isocyanate, and a low molecular weight linear polyester, and as a result, the resin is insufficiently kneaded, and in the case where it is used as a binder resin of a toner, it may cause problems in image quality.

[Patent Document 1] Japanese Patent No. 2988703

[Patent Document 2] Japanese Patent No. 2704282

[Patent Document 3] Japanese Patent No. 2986820

[Patent Document 4] Japanese Patent No. 3654766

### DISCLOSURE OF THE INVENTION

The present invention has been made under these circumstances, and an object thereof is to provide a resin composition for toners which enables to obtain a toner having excellent low temperature fixability, high temperature offset resistance, and excellent image quality a toner, and a method for preparing the resin composition for toners.

The present invention relates to a resin composition for toners, obtained by reacting a mixture of a branched polyester (A) having a number average molecular weight of 2,000 to 7,000 and a hydroxyl value of 20 to 80, and a low molecular weight linear polyester (B) having a number average molecular weight of 2,000 to 5,000 and a hydroxyl value of 20 to 55, with an isocyanate compound containing two or more isocyanate groups in one molecule,

which includes a crosslinked structure of said branched polyester (A), a structure in which said branched polyester (A) and said low molecular weight linear polyester (B) are bonded by the isocyanate compound, and an unreacted portion of said low molecular weight linear polyester (B).

Furthermore, the present invention relates to a method for preparing a resin composition for toners, including a process 1 in which a branched polyester and a low molecular weight linear polyester are introduced into a kneader equipped with a barrel and a screw, and melted; a process 2 in which the moisture contained in said branched polyester and said low molecular weight linear polyester is removed from the opening of said kneader equipped with a barrel and a screw, to provide said branched polyester and low molecular weight linear polyester with a water content of 0.3% by weight or less; and a process 3 in which an isocyanate compound containing two or more isocyanate groups in one molecule is added to, and reacted with said branched polyester and low molecular weight linear polyester having a water content of 0.3% by weight or less.

Hereinbelow, the present invention is described in detail.

The present inventors have conducted extensive studies, and as a result, they have found that when a mixture of a branched polyester and a low molecular weight linear polyester is reacted with an isocyanate compound to prepare a resin composition for toners, by the use of a low molecular weight linear polyester having a plurality of OH groups at its termini, the dispersion state of the resin can be maintained uniform without interfering with the original object of providing low temperature fixability exhibited by the low molecular weight linear polyester, and thus it enables to obtain a toner having excellent toner performances such as low temperature fixability, high temperature offset resistance, and high image quality. Based on this, they have completed the present invention.

The branched polyester (A) is preferably obtained by the reaction of dicarboxylic acids, diols, and tri- or higher-valent carboxylic acids or tri- or higher polyhydric alcohols.

As used herein, the phrase, a branched polyester, refers to a polyester having a branch structure in the polyester backbone.

As a method for reacting the dicarboxylic acids, diols, and tri- or higher-valent carboxylic acids or tri- or higher polyhydric alcohols, for example, a method in which dicarboxylic acids, diols, and tricarboxylic acid are introduced to a reactor in one portion for transesterification and condensation, or the like, can be employed. In this method, if the amount of the tricarboxylic acid to be added is too high, the reaction proceeds too fast, thereby possibly increasing the molecular weight. In such case, dicarboxylic acids and diols are first subject to transesterification, and then upon substantial completion of the transesterification, tricarboxylic acid is introduced, thereby obtaining a branched polyester having preferable physical properties.

Examples of the dicarboxylic acid include o-phthalic acid, terephthalic acid, isophthalic acid, succinic acid, adipic acid, sebacic acid, azelaic acid, octylsuccinic acid, cyclohexane dicarboxylic acid, naphthalene dicarboxylic acid, fumaric acid, maleic acid, itaconic acid, decamethylenecarboxylic acid, and an anhydride and lower alkyl ester thereof. Among these, in terms of giving crystallinity, terephthalic acid, naphthalenedicarboxylic acid, and an anhydride and lower alkyl ester thereof are preferably used.

Examples of the diol include aliphatic diols such as ethyleneglycol, 1,3-propanediol, 1,4-butanediol, diethylene glycol, 1,5-pentanediol, 1,6-hexanediol, dipropylene glycol, triethylene glycol, tetraethylene glycol, 1,2-propanediol, 1,3-butanediol, 2,3-butanediol, neopentyl glycol (2,2-dimethylpropane-1,3-diol), 1,2-hexanediol, 2,5-hexanediol, 2-methyl-2,4-pentanediol, 3-methyl-1,3-pentanediol, and 2-ethyl-1,3-hexanediol; and alicyclic diols such as 2,2-bis(4-hydroxycyclohexyl)propane, an adduct of 2,2-bis(4-hydroxycyclohexyl)propane with alkylene oxide, 1,4-cyclohexanediol, and 1,4-cyclohexane dimethanol. Among these, aliphatic diols are preferred.

As the tri- or higher-valent carboxylic acid, for example, tricarboxylic acid can be used. Furthermore, in addition to the tricarboxylic acid, pyromellitic acid, 1,2,7,8-octanetetracarboxylic acid, and an acid anhydride thereof and the like may be used. These may be used alone, or in combination of two or more thereof.

Examples of the tricarboxylic acid include trimellitic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, an acid anhydride thereof and the like.

Examples of the tri- or higher polyhydric alcohols include sorbitol, 1,2,3,6-hexanetetraol, 1,4-sorbitan, pentaerythritol, dipentaerythritol, tripentaerythritol, saccharose, 1,2,4-butanetriol, 1,2,5-pentanetriol, glycerol, 2-methylpropanetriol, 2-methyl-1,2,4-butanetriol, trimethylol ethane, trimethylol propane, 1,3,5-trihydroxymethyl benzene and the like. These may be used alone, or in combination of two or more thereof.

The lower limit of the amount of the tri- or higher-valent carboxylic acids or tri- or higher polyhydric alcohols to be added is preferably 0.5 mol %, and the upper limit of the range is preferably 20 mol %, based on the amount of the dicarboxylic acid to be added. With the amount of less than 0.5 mol %, the branch portions of the resulting branched polyester are reduced, thus leading to reduction in the reactivity with an isocyanate compound. Furthermore, even by the reaction with the isocyanate compound, a crosslinked polyester may not have sufficient crosslinking density, thereby resulting in insufficient high temperature offset resistance. With the amount of more than 20 mol %, crosslinking density may be increased, and high temperature offset resistance may be improved, but low temperature fixability may be lowered.

The branched polyester (A) has a number average molecular weight in the range of from a lower limit of 2,000 to an upper limit of 7,000. With the number average molecular weight of less than 2,000, the offset resistance and the durability of the resulting toner may be insufficient, whereas with the number average molecular weight of more than 7,000, the low temperature fixability of the resulting toner may be deteriorated. The upper limit is preferably 5,000.

The branched polyester (A) has a hydroxyl value in the range of from a lower limit of 20 to an upper limit of 80.

With the hydroxyl value of less than 20, the crosslinking reaction point of the branched polyester (A) is decreased, and thus the crosslinking density of the resulting crosslinked polyester is lowered. As a result, the high temperature offset resistance becomes insufficient. On the other hand, with the hydroxyl value of more than 80, the crosslinking reaction point of the branched polyester (A) is increased, and thus the crosslinking density of the resulting crosslinked polyester is increased. As a result, the high temperature offset resistance is improved, but the low temperature fixability is reduced.

The branched polyester (A) has an average branching degree in the range of from a preferable lower limit of 2.1 to a preferable upper limit of 7.0. With an average branching degree of less than 2.1, the crosslinking reaction point of the branched polyester (A) is decreased, and thus the crosslinking density of the resulting crosslinked polyester is decreased. As a result, the high temperature offset resistance may be reduced. With the average branching degree of more than 7.0, the crosslinking reaction point of the branched polyester (A) is increased, and thus the crosslinking density is increased. As a result, the high temperature offset resistance may be improved, but the low temperature fixability may be reduced.

As used herein, the term ‘an average branching degree’ refers to the number of the hydroxyl groups (NOH) per gram of the branched polyester (A), divided by the number of the molecules (N) per gram of the branched polyester (A), as shown in the following equation (1). NOH is expressed as NOH=1/Mn, using a number average molecular weight (Mn), and N is expressed as N=OHV×10⁻³/56.1, using the hydroxyl value (OHV) of the branched polyester (A). Accordingly, the average branching degree can be expressed with Mn and OHV.

Herein, the average branching degree of 2.0 indicates that the polyesters are all linear chained polyesters. The average branching degree of higher than 2.0 indicates that the proportion of the branched polyester (A) is proportionally higher.

$$\begin{matrix}[ Equation 1 ] & \\ \begin{matrix}Bu = NOH / N \\ = ( OHV \times {10}^{- 3} / 56.1 ) / ( 1 / Mn ) \\ = OHV \times Mn \times {10}^{- 3} / 56.1\end{matrix} & ( 1 )\end{matrix}$$

The branched polyester (A) preferably has a water content of 0.1% by weight or less. With the water content of more than 0.1% by weight, the polyester may be hydrolyzed, thereby resulting in significantly decreased molecular weight.

The method for measuring the water content of the branched polyester (A) is not particularly limited, but examples thereof include a determination method using a Karl Fischer titration in accordance with JIS K 7251, and a method for determining a weight increment after water absorption in accordance with JIS K 7209.

The branched polyester (A) has a water content of 0.1% by weight or less. Further, for he isocyanate group (NCO group) of the isocyanate compound, the equivalent ratio (OH group/NCO group) of the hydroxyl group (OH group) is in the range of from a preferable lower limit of 1 to a preferable upper limit of 28. With the equivalent ratio of less than 1, the high temperature offset resistance may be improved, but the low temperature fixability may be lowered. With the equivalent ratio of more than 28, the high temperature offset resistance may be insufficient.

A more preferable lower limit is 4, and a more preferable upper limit is 20.

The branched polyester (A) has a glass transition temperature in the range of from a preferable lower limit of 30° C. to a preferable upper limit of 80° C. With the glass transition temperature of lower than 30° C., sufficient high temperature offset resistance or anti-blocking property cannot be obtained, whereas with the glass transition temperature of higher than 80° C., the low temperature fixability is deteriorated. A more preferable lower limit is 50° C., and a more preferable upper limit is 65° C.

For the glass transition temperature of the branched polyester (A), an aromatic dicarboxylic acid such as terephthalic acid functions to increase the glass transition temperature, and a long-chained aliphatic dicarboxylic acid such as sebacic acid and adipic acid functions to decrease the glass transition temperature. Accordingly, a desired glass transition temperature can be accomplished by a suitable combination of these dicarboxylic acids. However, although a desired glass transition temperature can be accomplished by a suitable combination of an aromatic dicarboxylic acid and long-chained aliphatic dicarboxylic acid, the softening point tends to be too high.

Therefore, the branched polyester (A) is preferably obtained by polymerization of a monomer mixture of polyvalent carboxylic acids and polyhydric alcohols, containing either divalent bending monomers capable of incorporating a bending molecular structure into a molecular chain, or branched divalent monomers.

A polymer obtained by polymerization of a monomer mixture of the monomers containing these divalent bending monomers or branched divalent monomers allows to easily attain both of a desired glass transition temperature and a low softening point.

The divalent bending monomer is not limited to a dicarboxylic acid or diol, and any monomer which can incorporate a bending molecular structure into the molecular chain of a polymer such as an aromatic dicarboxylic acid substituted with a carboxylic group at an ortho- or meta-position, an aromatic diol substituted with a hydroxyl group at an ortho- or meta-position, a polycyclic aromatic dicarboxylic acid having a carboxylic group at an asymmetric position, a polycyclic aromatic diol having a hydroxyl group at an asymmetric position and the like. Examples of these monomers include dicarboxylic acid anhydrides, lower esters, monohydroxymonocarboxylic acids; a dicarboxylic acid such as anhydrous phthalic acid, o-phthalic acid, isophthalic acid, 1,4-naphthalenedicarboxylic acid, and 2,7-naphthalene dicarboxylic acid, and an anhydride or lower ester thereof; a monohydroxymonocarboxylic acid such as salicylic acid, and 3-hydroxy-2-naphthalenecarboxylic acid; and diols such as cathecorl and 1,4-cyclohexanedimethanol.

Furthermore, the branched divalent monomers effectively inhibit the crystallization of the polymers by steric hindrance of the branch chain. Examples of the branched monomers that can effectively inhibit the crystallization include an aliphatic diol having a branched alkyl chain, and an alicyclic diol having a branched alkyl chain. As the alicyclic diol, an alicyclic diol in which a plurality of alicyclic diols is connected via a branched alkylene chain is preferred.

The branched divalent monomer is not particularly limited, and examples thereof include an aliphatic diol such as 1,2-propanediol, 1,3-butanediol, 2,3-butanediol, neopentyl glycol (2,2-dimethylpropane-1,3-diol), 1,2-hexanediol, 2,5-hexanediol, 2-methyl-2,4-pentanediol, 3-methyl-1,3-pentanediol, 2-ethyl-1,3-hexanediol, 2-butyl-2-ethyl-1,3-propanediol, and 2,4-diethyl-1,5-pentanediol; and an alicyclic diol such as 2,2-bis(4-hydroxycyclohexyl)propane and an adduct of 2,2-bis(4-hydroxycyclohexyl)propane with alkylene oxide adduct.

For the resin composition for toners of the present invention, as the low molecular weight linear polyester (B), those having a number average molecular weight of 2,000 to 5,000, and a hydroxyl value of 20 to 55 (hereinafter, also referred to as a low molecular weight linear polyester having a terminal hydroxyl group) are used.

If the branched polyester (A) and the low molecular weight linear polyester having a terminal hydroxyl group are mixed, and then reacted with an isocyanate compound, a structure in which the branched polyester (A) and the low molecular weight linear polyester (B) are bonded by the isocyanate compound is formed, in addition to a crosslinked structure of the branched polyester (A) and an unreacted portion of the low molecular weight linear polyester (B), since most of both of the terminal groups of the branched polyester (A) and the low molecular weight linear polyester having a terminal hydroxyl group are hydroxyl groups.

Since such the structure in which the branched polyester (A) and the low molecular weight linear polyester (B) are bonded by the isocyanate compound is easily compatible with either of the crosslinked structure of the branched polyester (A) and the unreacted portion of the low molecular weight linear polyester (B), the resulting resin composition for toners has a constitution in which the crosslinked polyester having a suitable crosslinking density is uniformly mixed with the low molecular weight linear polyester (B). By this, it enables to prepare a toner having excellent balance between low temperature fixability and high temperature offset resistance. Furthermore, when a toner is prepared by attaining a constitution in which the low molecular weight linear polyester (B) is uniformly mixed, it is possible to prepare a toner having a good dispersibility with a blending agent such as a releasing agent, a coloring agent, an electric charge controlling agent, and magnetic powders, and thus an excellent image quality.

In the present specification, the term ‘a linear polyester’ refers to a polyester in which an ester structure is in the form of a linear chain. However, the terminal portion of the linear polyester may be acid-modified with carboxylic acid, etc.

The low molecular weight linear polyester (B) is not particularly limited, and those obtained by polycondensation of dicarboxylic acids and diols can be used.

As the dicarboxylic acid and the diol, the same ones as described for the branched polyester (A) can be used.

The low molecular weight linear polyester (B) has a number average molecular weight in the range of from a preferable lower limit of 2,000 to a preferable upper limit of 5,000. With the number average molecular weight of less than 2,000, the anti-blocking property of the resulting toner may be insufficient, whereas with the number average molecular weight of more than 5,000, the low temperature fixability may be lowered.

The hydroxyl value of the low molecular weight linear polyester (B) varies depending on an average molecular weight, but it is in the range of from a lower limit of 20 to an upper limit of 55. With the hydroxyl value of less than 20, the low temperature fixability of the resulting toner is lowered, whereas with the hydroxyl value of more than 55, the anti-blocking property is insufficient.

The low molecular weight linear polyester (B) has a glass transition temperature in the range of from a preferable lower limit of 30° C. to a preferable upper limit of 80° C. With the glass transition temperature of lower than 30° C., the anti-blocking property may not be sufficiently obtained, whereas with the glass transition temperature of higher than 80° C., the effect of improvement in the low temperature fixability may not be exhibited by addition of the low molecular weight linear polyester (B).

The mixing weight ratio of the branched polyester (A) to the low molecular weight linear polyester (B) is preferably 20:80 to 80:20. With the proportion of the branched polyester (A) of less than 20% by weight, the reactivity with the isocyanate compound may be lowered, whereas with the proportion of more than 80% by weight, the content of the low molecular weight components may be too low, thereby resulting in reduced low temperature fixability of the resulting toner. The mixing weight ratio is more preferably 30:70 to 70:30.

The isocyanate compound has two or more isocyanate groups in one molecule. If the number of the isocyanate groups in one molecule is less than 2, production of a crosslinked polyester is insufficient, and the high temperature offset resistance is lowered.

Preferably, the number of the isocyanate groups in one molecule is 3 or more. By incorporating three or more isocyanate groups in one molecule, the reactivity between the branched polyester (A) and the isocyanate compound is improved, and the crosslinking density is suitable. Thus, it is possible to prepare a resin composition for toners that can provide a toner having excellent high temperature offset resistance.

In the isocyanate compound, the content of the isocyanate groups is in the range of from a preferable lower limit of 0.3 moles to a preferable upper limit of 3 moles, based on 1 mole of the branched polyester (A). With the content of the isocyanate groups of less than 0.3 moles, production of a crosslinked polyester is insufficient, and the high temperature offset resistance is lowered. With the content of the isocyanate groups of more than 3 moles, excessive isocyanate compounds that do not involve in crosslinking are increased, and the substantial physical properties of the isocyanate compound itself are exhibited, thereby deterioration of the physical properties such as low temperature fixability.

The isocyanate compound is not particularly limited as long as it has two or more isocyanate groups in one molecule. Examples of the isocyanate compound include isophorone diisocyanate, 2,4-tolylene diisocyanate, 2,6-tolylene diisocyanate, hexamethylene diisocyanate, trimethylhexamethylene diisocyanate, diphenylmethane-4,4′-diisocyanate (MDI), hydrogenated MDI, polymeric MDI, 1,5-naphthalene diisocyanate, norbornane diisocyanate, tolidine diisocyanate, xylylene diisocyanate (XDI), hydrogenated XDI, lysine diisocyanate, triphenylmethane triisocyanate, tris(isocyanatophenyl)thiophosphate, tetramethylxylene diisocyanate, and 1,6,10-undecane triisocyanate.

In the present invention, after the branched polyester (A) and the low molecular weight linear polyester (B) are reacted with the isocyanate compound, other polyesters may be additionally added, within the range of not interfering with the characteristics of the resulting resin composition for toners.

Examples of other polyester include a linear polyester having a number average molecular weight of 2,000 to 10,000. By introducing a linear polyester having a number average molecular weight of 2,000 to 10,000 (hereinafter simply referred to as a linear polyester), after crosslinking, the crosslinking density of the resulting crosslinked polyester can be appropriately set, and thus the crosslinked polyester and the linear polyester can be further uniformly mixed.

As the linear polyester, for examples, those obtained by polycondensation of dicarboxylic acids and diols can be used.

As the dicarboxylic acid and the diol, the same ones as described for the branched polyester (A) can be used.

The linear polyester has a number average molecular weight in the range of from a preferable lower limit of 2,000 to a preferable upper limit of 10,000. With the number average molecular weight of less than 2,000, the anti-blocking property of the toner may be insufficient, whereas with the number average molecular weight of more than 10,000, the low temperature fixability may be lowered. A more preferable lower limit is 2,500, and a more preferable upper limit is 6,000.

In the present invention, if other polyesters are added, a preferable upper limit of the addition amount is 30% by weight. With the amount of more than 30% by weight, the low temperature fixability and the high temperature offset resistance of the resulting toner may be deteriorated. A preferable lower limit is 20% by weight.

In the present invention, the branched polyester (A) and the low molecular weight linear polyester (B) may be reacted with the isocyanate compound in the presence of moisture. By using such method, a crosslinked polyester having a number of urea bonds within the molecule can be prepared. By this, the resulting crosslinked polyester has excellent heat resistance, and is hard to be thermally decomposed during heating, thereby providing a resin having stable physical properties.

The method for reaction in the presence of moisture is not particularly limited, and examples thereof include a method in which a branched polyester containing water as a raw material is used, and a method in which water is introduced at the same time with the raw materials and the like.

If a polyester containing water as a raw material is used, a preferable lower limit of the moisture amount is 0.01% by weight and a preferable upper limit of the moisture amount is 1.0% by weight. With the moisture amount of less than 0.01% by weight, sufficient urea bonds may not be formed, whereas with the moisture amount of more than 1.0% by weight, the polyester may be hydrolyzed, thereby resulting in significant decrease in molecular weight.

In the present invention, it is preferable that a polyhydric alcohol is further added after the branched polyester (A) and the low molecular weight linear polyester (B) are reacted with the isocyanate compound. By this, a crosslinked polyester having a desired crosslinking density can be obtained.

The polyhydric alcohol is not particularly limited, and examples thereof include sorbitol, 1,2,3,6-hexanetetraol, 1,4-sorbitan, pentaerythritol, dipentaerythritol, tripentaerythritol, saccharose, 1,2,4-butanetriol, 1,2,5-pentanetiol, glycerol, 2-methylpropanetriol, 2-methyl-1,2,4-butanetriol, trimethylol ethane, trimethylol propane, 1,3,5-trihydroxymethyl benzene and the like. These may be used alone, or in combination of two or more thereof.

The amount of the polyhydric alcohol to be added is in the range of from a preferable lower limit of 0.01% by weight to a preferable upper limit of 3.0% by weight. With the amount of less than 0.01% by weight, the effect of addition of the polyhydric alcohol is not sufficiently exhibited, whereas with the amount of more than 3.0% by weight, the crosslinking density may be too high, thereby resulting in reduced dispersibility of the low molecular weight linear polyester (B).

The method for reacting the branched polyester (A) and the low molecular weight linear polyester (B) with the isocyanate compound is not particularly limited, as long as the above-described isocyanate reaction sufficiently proceeds, and examples thereof include a method for reacting under melting and kneading by means of using a reaction vessel or a melt extruder at a temperature at which the isocyanate reaction sufficiently proceeds. Among these, for the reasons, for example, that the crosslinking reaction of the branched polyester (A) with the isocyanate compound can sufficiently proceed and that continuous production can be performed, or the like, a single screw or a twin screw extruding kneader is preferred, and a twin screw extruding kneader is more preferred.

The resin composition for toners of the present invention, as prepared by using the above-described method, contains a crosslinked structure of the branched polyester (A), a structure in which the branched polyester (A) and the low molecular weight linear polyester (B) are bonded by the isocyanate compound, and an unreacted portion of the low molecular weight linear polyester (B).

Since the resin composition for toners of the present invention contains a crosslinked structure of the branched polyester (A), the resulting toner can retain high temperature offset resistance. Furthermore, since it contains an unreacted portion of the low molecular weight linear polyester (B), it can contribute to exhibition of low temperature fixability.

Moreover, since the resin composition for toners of the present invention contains a structure in which the branched polyester (A) and the low molecular weight linear polyester (B) are bonded by the isocyanate compound, the compatibility of the crosslinked structure of the branched polyester (A) and the low molecular weight linear polyester (B) can be significantly improved. As a result, the resin composition for toners of the present invention has a constitution in which the low molecular weight linear polyester (B) is uniformly mixed with a crosslinked polyester having a suitable crosslinking density, and thus it enables to prepare a toner that has excellent balance between the low temperature fixability and the high temperature offset resistance. Furthermore, in the preparation of the toner, a toner having excellent image quality can be prepared, due to improvement in dispersibility of additives such as a releasing agent, a coloring agent, an electric charge controlling agent, magnetic powders and the like.

The resin composition for toners of the present invention preferably contains an unreacted portion of the branched polyester (A) having a molecular weight that is not more than the peak molecular weight of the branched polyester (A) before reaction (hereinafter also referred to as an unreacted portion of the branched polyester (A)), and the low molecular weight linear polyester (B).

As used herein, the unreacted portion of the branched polyester (A) refers to a component remaining after the reaction of the branched polyester (A), the low molecular weight linear polyester (B), and the isocyanate compound. It also collectively refers to a molecular weight fraction having a molecular weight that is no more than the resulting peak molecular weight, as measured by means of gel permeation chromatography using the tetrahydrofuran soluble fraction of the branched polyester (A) before reaction, which encompasses the branched polyester (A), as well as the low molecular weight linear polyester (B).

The resin composition for toners of the present invention can provide the resulting toner with suitable low temperature fixability, by incorporation of the unreacted portion the branched polyester (A).

Furthermore, the compatibility between the crosslinked structure including the branched polyester (A) and the isocyanate compound, and the unreacted portion of the branched polyester (A) is extremely good. As a result, the resin composition for toners of the present invention has a constitution in which the unreacted portion of the branched polyester (A) is uniformly mixed with a crosslinked structure having a suitable crosslinking density. Accordingly, it enables to obtain a toner having excellent balance between the low temperature fixability and the high temperature offset resistance, and to prepare a toner having excellent image quality, due to improvement in dispersibility of additives such as a releasing agent, a coloring agent, an electric charge controlling agent, magnetic powders and the like.

The method for measuring the content of the unreacted portion of the branched polyester (A) in the resin composition for toners of the present invention is not particularly limited, but the content can be determined by measuring the area ratio of a peak area in the range corresponding to the molecular weights that are not more than the peak molecular weight of the branched polyester before reaction, based on the total peak area, and it can be taken as a standard for the content of the unreacted portion of the branched polyester (A), in the measurement of the molecular weight distribution of a tetrahydrofuran soluble fraction (hereinafter also referred to as a THF soluble fraction) in the resin composition for toners of the present invention by means of gel permeation chromatography (hereinafter also referred to as GPC).

As a means for measuring the area ratio of a peak area in the range corresponding to the molecular weights that are not more than the peak molecular weight of the branched polyester (A) before reaction, based on the total peak area, the following method can be used.

FIGS. 1a and b are curves of the molecular weight distributions obtained by measurement of THF soluble fractions of the branched polyester (A) before reaction and the resin composition for toners of the present invention, by means of GPC.

First, an area of an A region of the total peak area is determined from the molecular weight distribution curve (FIG. 1a) obtained by measurement of the THF soluble fraction of the branched polyester (A) before reaction, by means of GPC. Next, an area of a B region in the range corresponding to the molecular weights that are no more than the peak molecular weight (x in FIG. 1b) by preliminarily measuring the molecular weight distribution curve of the branched polyester (A) before reaction, is determined by the dashed molecular weight distribution curve (FIG. 1b). Then, by determining the ratio of the B region to the A region, the area ratio of the peak area in the range corresponding to the molecular weights that are not more than the peak molecular weight of the branched polyester (A) before reaction, based on the total peak area, can be determined.

In the measurement of the molecular weight distribution of the THF soluble fraction in the resin composition for toners of the present invention by means of GPC, the peak area in the range corresponding to the molecular weights that are not more than the peak molecular weight of the branched polyester before reaction is in the range of from a preferable lower limit of 20% to a preferable upper limit of 45%, based on the total peak area. With the peak area of less than 20%, high temperature offset resistance is improved, but low temperature fixability may be lowered. With the peak area of more than 45%, high temperature offset resistance may be insufficient.

The apparatus for measurement of GPC is not particularly limited, and examples thereof include HTR-C (manufactured by Nihon Millipore Ltd.), GPC-101 (manufactured by SHOWA DENKO K. K.) and the like.

The column used for GPC is not particularly limited, and examples thereof include KF-800 series (manufactured by SHOWA DENKO K. K.), TSK-GEL HHR series (manufactured by TOSOH CORPORATION) and the like.

Furthermore, the resin composition for toners of the present invention has a tetrahydrofuran insoluble fraction (gel fraction) in the range of from a preferable lower limit of 1% by weight to a preferable upper limit of 40% by weight. With the tetrahydrofuran insoluble fraction of less than 1% by weight, high temperature offset resistance may be lowered, whereas with the tetrahydrofuran insoluble fraction of more than 40% by weight, low temperature fixability may be insufficient.

The resin composition for toners of the present invention has a swelling rate, as measured by immersing it in tetrahydrofuran, shaking at ambient temperature for 16 hours, and then filtering it through a 200-mesh metal wire filter, in the range of from a preferable lower limit of 500% to a preferable upper limit of 4,000%.

The swelling rate is an indirect indicator of mixing uniformity of the crosslinked polyester and the linear polyester in the resin composition for toners, since it is related to the crosslinking density of the crosslinked polyester.

Accordingly, if the swelling rate is in this range, it is believed that the crosslinked structure is formed with a suitable density, and further the crosslinked polyester and the linear polyester are uniformly mixed, and therefore, the resulting toner can have compatibility between low temperature fixability and high temperature offset resistance.

With the swelling rate of less than 500%, the crosslinking density is too high. Thus, high temperature offset resistance is improved, but low temperature fixability may be lowered. With the swelling rate of more than 4,000%, crosslinking density is too low, thereby resulting in insufficient high temperature offset resistance. A more preferable lower limit is 700%, and a more preferable upper limit is 3,500%.

The resin composition for toners of the present invention has a flow softening point in the range of from a lower limit of 100° C. to an upper limit of 160° C. With the flow softening point of lower than 100° C., the high temperature offset resistance may be insufficient, whereas with the flow softening point of higher than 160° C., the low temperature fixability may be lowered. A preferable upper limit is 150° C., and a more preferable upper limit is 145° C.

As used herein, the flow softening point is a temperature, Tf, at which a median plunger descent amount h/2 is given in the plunger descent amount at a flow start point of a resin and the plunger descent amount at a flow end point of a resin, when a relationship between a plunger descent amount and a temperature is determined by melt flowing 1.0 g of a measurement sample that is passing through a JIS standard sieve having a mesh size of 1.19 mm, under the conditions of a load of 20 kg/cm², an orifice of 1 mmφ×1 mm, a preliminary temperature of 60° C., a preliminary time of 5 minutes, a chart speed of 20 mm/min, a plunger of 1.0 cm², and a temperature elevation rate of 6±0.5° C./min, for example, using a Kouka-shiki flow tester (for example, “CFT-500 type” manufactured by Shimadzu Corporation, etc.).

FIG. 2 shows a drawing representing the relationship of the plunger descent amount and the time (temperature), when determining the flow softening point, Tf, by equal velocity temperature elevation method.

The resin composition for toners of the present invention, when a 450% shear strain is applied under the condition of 170° C., has a relaxation modulus G_{170° C.} (0.1) at 0.1 sec after application of the shear strain in the range of from a preferable lower limit of 100 Pa to a preferable upper limit of 1500 Pa.

The present inventors have investigated extensively, and as a result, they have found that an offset phenomenon in the toner occurs when the aggregation force of the molten toner is lower than the adhesive force between the toner and a heat fixation roller, and that high temperature offset resistance of the toner has relationship with the magnitude of the aggregation force of the resin composition for toners and the relaxation modulus of the resin composition for toners under large deformation. Furthermore, the present inventors have investigated more extensively, and as a result, they have found that by using a resin composition for toners having a certain relaxation modulus, low temperature fixability can be improved, while maintaining high temperature offset resistance of the toner.

The relaxation modulus can be measured, for example, by using a test sample obtained by melting the resin composition for toners of the present invention, and molding it into a disc with a predetermined size, by means of a relaxation modulus measurement device (for example, ARES manufactured by TA Instruments, etc.).

The acid value of the resin composition for toners of the present invention is not particularly limited, but it is in the range of from a preferable lower limit of 1 to a preferable upper limit of 30. This acid value is derived from the above crosslinked polyester or functional groups on the terminal of the linear polyester, specifically, for example, a carboxylic group, and the like. With the acid value in this range, the resulting toner has excellent low temperature fixability, and improved affinity with paper.

The resin composition for toners of the present invention can be prepared, for example, by the method for preparing a resin composition for toners as follows.

The method for preparing a resin composition for toners of the present invention includes a process 1 in which a branched polyester and a low molecular weight linear polyester are introduced into a kneader equipped with a barrel and a screw, and melted; a process 2 in which the moisture contained in the branched polyester and the low molecular weight linear polyester is removed from the opening of the kneader equipped with a barrel and a screw, to provide the branched polyester and the low molecular weight linear polyester with a water content of 0.3% by weight or less; and a process 3 in which an isocyanate compound containing two or more isocyanate groups in one molecule is added to, and reacted with the branched polyester and the low molecular weight linear polyester having a water content of 0.3% by weight or less.

The present inventors have conducted extensive studies, and as a result, they found out that a toner having excellent toner performances such as low temperature fixability, high temperature offset resistance, and high image quality, by introducing a branched polyester and a low molecular weight linear polyester into a kneader equipped with a barrel and a screw, and melting; removing the moisture contained in the branched polyester and the low molecular weight linear polyester from the opening of the kneader equipped with a barrel and a screw, to reduce the water content of the branched polyester and the low molecular weight linear polyester to a specific ratio; and adding an isocyanate compound thereto to be efficiently reacted with the molten, branched polyester and low molecular weight linear polyester. Based on this, they have completed the present invention.

In the method for preparing a resin composition for toners of the present invention, a kneader equipped with a barrel and a screw is used. By using such the kneader, a branched polyester, a low molecular weight linear polyester, and an isocyanate compound can be continuously fed and kneaded, and further a crosslinking reaction of a branched polyester and a low molecular weight linear polyester with an isocyanate compound can sufficiently proceed, and accordingly, it is possible to continuously prepare the resin composition for toners of the present invention.

The kneader equipped with a barrel and a screw is not particularly limited, and examples thereof include a single screw extruding kneader, a twin screw extruding kneader such as a twin screw co-rotating extruding kneader, and a twin screw counter-rotating extruding kneader, and a four-screw extruding kneader, a feeder-ruder, a kneader, and an injecting molder and the like. Among these, a twin screw extruding kneader is preferable.

It is preferable that the kneader equipped with a barrel and a screw has a feed part for feeding a branched polyester and a low molecular weight linear polyester from an upstream position, an opening part for removing the moisture contained in the branched polyester and the low molecular weight linear polyester, and an addition part for adding an isocyanate compound, in this order.

By having this structure, a branched polyester and a low molecular weight linear polyester are molten, the moisture contained in the branched polyester and the low molecular weight linear polyester is removed, and then an isocyanate compound is added thereto, to perform a crosslinking reaction.

FIG. 3 is a schematic diagram for illustrating one example of a kneader equipped with a screw for carrying out the method for preparing a resin composition for toners of the present invention. As shown in FIG. 3, in an extruding kneader 1, a feed part 2, an opening part 3, and an addition part 4 are disposed from an upstream position, in this order.

In the present invention, first, the branched polyester and the low molecular weight linear polyester are fed from the feed part 2 by means of a metering feeder, and melt kneaded by heating. Thereafter, the moisture contained in the branched polyester and the low molecular weight linear polyester is removed from the opening part 3 to provide the branched polyester with a predetermined water content, and then an isocyanate compound is continuously fed from the addition part 4. Then, the mixture was further melt kneaded, and then the branched polyester and the low molecular weight linear polyester can be reacted with the isocyanate compound to prepare a resin composition for toners.

The kneader equipped with the screw has a ratio [L/D] of the length (L) to the diameter (D) of the screw in the range of from a preferable lower limit of 20 to a preferable upper limit of 100. With the ratio of less than 20, the length of the screw is small, and thus melting, dehydrating, kneading, reaction, or the like may be insufficient. With the ratio of more than 100, the heating time is long, and thus the resulting crosslinked polyester may be thermally decomposed or thermally deteriorated. In this regard, high temperature offset resistance may not be improved. A more preferable lower limit is 30, and a more preferable upper limit is 60.

To efficiently remove the moisture from the opening part, the screw preferably has a sealing constitution, after the process 1 for melting the branched polyester and the low molecular weight linear polyester, and before the process 3 for adding the isocyanate compound, respectively. By including this sealing constitution, it is possible to stably remove the moisture contained in the branched polyester.

The sealing constitution is not particularly limited, but for this, for examples, in the case of using a twin screw co-rotating extruder, a reverse screw, a kneading disc, a seal ring, or the like can be used.

The opening part is not particularly limited, as long as the moisture contained in the branched polyester can be removed from the opening part, but for this, for examples, a venting hole is preferred, and a vacuum venting hole equipped with a pressure-reducing apparatus, wherein by pressure-reducing the inside of the venting hole and a part of the screw to form a vacuum atmosphere, is more preferred.

By using the vacuum venting hole as the opening part of the kneader equipped with the screw, the moisture contained in the branched polyester can be removed under reduced pressure, thereby resulting in effective removal of the moisture.

The opening part is not limited, as long as it enables the moisture contained in the branched polyester to be removed under atmospheric pressure. However, in the case of using the vacuum venting hole, by reducing pressure by means of a pressure-reducing apparatus, the water content of the branched polyester can be effectively lowered. In the case where the vacuum venting hole is used to reduce pressure, the vacuum degree has a preferable upper limit of 200 Torr, a more preferable upper limit of 100 Torr, or an even more preferable upper limit of 30 Torr.

In the opening part, the ratio [L/D] of the length (L) to the diameter (D) of the screw has a preferable lower limit of 1, or a more preferable lower limit of 5. A longer screw in the opening part enables the moisture to be more sufficiently removed, but it is important to keep balance with the total length of the kneader used.

The method for preparing a resin composition for toners of the present invention includes a process 1 in which a branched polyester and a low molecular weight linear polyester are introduced into a kneader equipped with a barrel and a screw, and melted.

The temperature at which the branched polyester and the low molecular weight linear polyester are melt is not particularly limited, but it is in the range of from a preferable lower limit of 50° C. to a preferable upper limit of 200° C. With the temperature of lower than 50° C., the branched polyester and the low molecular weight linear polyester may not be sufficiently molten. With the temperature of higher than 200° C., the branched polyester and the low molecular weight linear polyester may be thermally decomposed or thermally deteriorated, thereby resulting in deterioration of high temperature offset resistance of the resulting toner.

In the process 1, it is preferable that the branched polyester and the low molecular weight linear polyester are further heated to 120° C. or higher, and molten. By heating them to 120° C. or higher, the moisture, a volatile fraction, or the like contained in the branched polyester and the low molecular weight linear polyester can be removed.

The temperature at which the branched polyester and the low molecular weight linear polyester are molten has a preferable upper limit of 180° C. With the temperature of higher than 180° C., the branched polyester may be thermally decomposed or thermally deteriorated, thereby resulting in deterioration of high temperature offset resistance of the resulting toner.

The method for preparing a resin composition for toners of the present invention includes a process 2 in which the moisture contained in the branched polyester and the low molecular weight linear polyester is removed from the opening of the kneader equipped with the screw, to provide the branched polyester and the low molecular weight linear polyester with a water content of 0.3% by weight or less.

As a conventional method for removing the moisture from the branched polyester, a method including preliminarily drying a solid branched polyester, etc. in vacuo have been used. However, in this method, it takes 20 minutes or longer to stabilize the water content of the branched polyester to 0.3% by weight or less, or the melting point of the branched polyester is low, and as a result, the branched polyester may coalesce upon heating, a trace amount of moisture may remain in the inside of the branched polyester, or the moisture in the air may be absorbed in a short time until it is introduced into a kneader. To the contrary, in the present invention, when the moisture contained in the branched polyester is removed, by keeping the branched polyester in the molten state, the moisture is sufficiently removed from the branched polyester, and further the branched polyester having the moisture removed is reacted with an isocyanate compound in a continuous process. As a result, the moisture does not substantially interfere with the reaction.

When the moisture contained in the branched polyester is removed, the temperature of the branched polyester is not particularly limited, but it has a preferable lower limit of 80° C. With the temperature of lower than 80° C., the moisture may not be efficiently removed from the molten branched polyester. A more preferable lower limit is 100° C.

In the process 2, it is preferable that the temperature of the molten branched polyester and the low molecular weight linear polyester is controlled at 90 to 130° C. By controlling the branched polyester and the low molecular weight linear polyester at 90 to 130° C., it is possible to finely disperse the added isocyanate compound in the branched polyester and the low molecular weight linear polyester as describe below.

As described above, in the method for preparing a resin composition for toners of the present invention, it is preferable to heat the branched polyester to 120° C. or higher in the process 1, but it is usually necessary to thoroughly heating the barrel around the feed part 2 in order to rapidly control the temperature of the branched polyester and the low molecular weight linear polyester at 120° C. or higher, after supplying them. Therefore, unless the temperature is not controlled by using any means for cooling, the temperature of the branched polyester and the low molecular weight linear polyester is elevated to over 120° C. even after melting. In the method for preparing a resin composition for toners of the present invention, it is important to control the temperature of the branched polyester and the low molecular weight linear polyester at 90 to 130° C., while inhibiting elevation of the temperature of the polyesters.

The method for control the temperature of the branched polyester and the low molecular weight linear polyester at 90 to 130° C. is not particularly limited, but examples thereof include a method in which the barrel and the screw of a kneader having the barrel and the screw is cooled by cooling water, etc.

The water content of the branched polyester and the low molecular weight linear polyester having the moisture removed has an upper limit of 0.3% by weight. With the water content of more than 0.3% by weight, the moisture contained in the branched polyester interferes with a reaction of the branched polyester and the low molecular weight linear polyester with the isocyanate compound, and thus the resulting resin composition for toners cannot have a sufficiently high viscosity, and a toner obtained therefrom cannot exhibit high temperature offset resistance. A preferable upper limit is 0.1% by weight.

The method for preparing a resin composition for toners of the present invention includes a process 3 in which an isocyanate compound containing two or more isocyanate groups in one molecule is added to, and reacted with the branched polyester and the low molecular weight linear polyester having a water content of 0.3% by weight or less.

By adding an isocyanate compound to the branched polyester and the low molecular weight linear polyester having a water content of 0.3% by weight or less, the reaction sufficiently proceeds, without causing the moisture to interfere with the reaction. As a result, it is possible to produce a crosslinked polyester.

In the process 3, the temperature of the branched polyester and the low molecular weight linear polyester upon addition of an isocyanate compound is in the range of from a preferable lower limit of 90° C. to a preferable upper limit of 130° C. With the temperature of lower than 90° C., the melt viscosity of the branched polyester and the low molecular weight linear polyester may be too high, and thus the isocyanate compound, if added, cannot be finely dispersed. As a result, a crosslinked polyester having a uniform and suitable crosslinked structure may not be formed, and thus a toner obtained therefrom may not be exhibit high temperature offset resistance. With the temperature of higher than 130° C., when the isocyanate compound is added, the branched polyester and the low molecular weight linear polyester with the isocyanate compound begin to react with each other before the isocyanate compound is sufficiently dispersed. As a result, since the isocyanate compound cannot be finely dispersed, a crosslinked polyester having a uniform and suitable crosslinked structure may not be formed, and thus a toner obtained therefrom may not exhibit high temperature offset resistance.

Thus, by setting the temperature of the branched polyester and the low molecular weight linear polyester at 90 to 130° C. when the isocyanate compound is added thereto, the isocyanate compound can be sufficiently dispersed in the branched polyester and the low molecular weight linear polyester before the branched polyester and the low molecular weight linear polyester with the isocyanate compound begin to react with each other. As a result, it is possible to prepare a resin composition for toners having a uniform and suitable crosslinked structure can be prepared, and further, a toner obtained therefrom can have excellent properties as a toner, such as low temperature fixability and high temperature offset resistance.

The kneading temperature after addition of the isocyanate compound is not particularly limited, as long as it allows the reaction of the branched polyester and the low molecular weight linear polyester with the isocyanate compound to sufficiently proceed, thereby obtaining a crosslinked polyester. A preferable lower limit is 100° C., and a preferable upper limit is 230° C. With temperature of lower than 100° C., the crosslinking reaction hardly proceeds, and production of a crosslinked polyester may be insufficient. With the kneading temperature of higher than 230° C., the produced crosslinked polyester may be thermally decomposed or thermally deteriorated, and thus high temperature offset resistance may not be improved. A more preferable upper limit is 200° C.

After the isocyanate compound is added to the branched polyester and the low molecular weight linear polyester, the retention time in the extruding kneader is in the range of from a preferable lower limit of 3 minutes to a preferable upper limit of 30 minutes. With the retention time of less than 3 minutes, a crosslinking reaction of the branched polyester and the low molecular weight linear polyester with the isocyanate compound may be insufficient. With the retention time of more than 30 minutes, the produced crosslinked polyester may be thermally decomposed or thermally deteriorated, and thus high temperature offset resistance may not be improved. A more preferable upper limit is 20 minutes.

The resin composition for toners of the present invention is used as a binder resin, and if necessary, a resin for toners including a releasing agent, a coloring agent, an electric charge controlling agent, a magnetic substance, a rubber polymer, and a styrene-acrylic acid ester copolymer, a carrier, a cleaning performance-improving agent, or the like can be blended, to prepare a toner. This toner is also included in the present invention.

Since the toner of the present invention is excellent in both of low temperature fixability and high temperature offset resistance by using the resin composition for toners of the present invention, it is not necessary to contain a releasing agent.

The releasing agent is not particularly limited, and examples thereof include an olefinic wax or paraffin wax, such as a polypropylene wax, a polyethylene wax, a microcrystalline wax, and an oxidized polyethylene wax; a wax containing an aliphatic ester, such as carnauba wax, sasol wax, and montanic acid ester wax; deoxidizing carnauba wax; a wax containing a saturated aliphatic acid, such as palmitic acid, stearic acid, and montanic acid; a wax containing an unsaturated aliphatic acid, such as brassidic acid, eleostearic acid, and parinaric acid; a wax containing a saturated alcohol, such as stearyl alcohol, aralkyl alcohol, behenyl alcohol, carnaubyl alcohol, ceryl alcohol, and melissyl alcohol; a wax containing a polyhydric alcohol, such as sorbitol; a wax containing a saturated aliphatic acid amide, such as linolicamide, oleicamide, and lauricamide; a wax containing a saturated aliphatic acid bisamide, such as methylene-bisstearicamide, ethylene-biscapricamide, ethylene-biscapricamide, and hexamethylen-biscapricamide; a wax containing an unsaturated acid amide, such as ethylene bisoleic acid amide, hexamethylenebisoleic acid amide, N,N′-dioleyl adipic acid amide, and N,N′-dioleylsebacic acidamide; a wax containing an aromatic bisamide, such as m-xylene-bisstearoicamide, and N,N′-distearylisophthaliclamide; a wax containing an aliphatic acid metal salt, such as calcium stearate, calcium laurate, zinc stearate, and magnesium stearate; a graft modified wax obtained by conducting graft polymerization of a polyolefin with vinyl monomers, such as styrene and acrylic acid; a wax of a partially esterified ester between an aliphatic acid such as behenic acid, and polyhydric alcohol; a wax of a methylester having a hydroxyl group as obtained by hydrogenating a vegetable fat and oil; a wax of an ethylene-vinyl ester copolymer wax having a high content of ethylene components; a wax of a long-chained alkyl acrylate such as a wax of saturated stearyl acrylate such as acrylic acid; and a wax of an aromatic acrylate such as a wax of benzyl acrylate wax. Among these, a long chain alkyl acrylate wax or an aromatic acrylate wax is preferable since it is highly compatible with a resin composition for toners and gives a highly transparent toner. These releasing agents may be used alone, or in combination of two or more kinds thereof, but in particular, preferably in combination of two or more kinds of the releasing agents having a different melting point of 30° C. or higher.

The size of the releasing agent in the toner is not particularly limited, but a long diameter is preferably 2 μm or less.

The coloring agent is not particularly limited, but examples thereof include a carbon black such as furnace black, lamp black, thermal black, acetylene black, and channel black; aniline black, phthalocyanine blue, quinoline yellow, lamp black, rhodamine-B, an azo-based pigment, a perylene-based pigment, a perynone-based pigment, an anthraquinone-based pigment, a dioxazine-based pigment, an isoindoline-based pigment, an isoindolinone-based pigment, a threne-based pigment, an indigo-based pigment, quinophthalone, diketopyrrolopyrrole, and quinacridone.

The amount of the coloring agent to be blended is generally in the range of from a preferable lower limit of 1 part by weight to a preferable upper limit of 10 parts by weight, based on 100 parts by weight of a resin composition for toners.

The electric charge controlling agent mentioned above may be any of the two types, namely, a positive charge controller and a negative charge controller. Examples of the positive charge controlling agent include a nigrosine dye, an ammonium salt, a pyridinium salt, and azine, while examples of the negative charge controlling agent include a chromium complex, and an iron complex. Among theses, an acid-modified electric charge controlling agent is preferred, and it exhibits a rubber elasticity as a result of the crosslinking with a resin composition for toners when it is modified with salicylic acid. The metal complex of an alkyl-substituted salicylic acid such as a di-tert-butylsalicylic acid chromium complex and a di-tert-butylsalicylic acid zinc complex is preferred, since it is colorless or has a pale color which does not affect the toner color tone. Furthermore, as the electric charge controlling agent, an electric charge controlling resin (CCR) may be preferably used. Examples of the electric charge controlling resin include styrene/acryl polymers obtained by copolymerization of monomers containing a quaternary ammonium salt, organic fluorine-based monomers, sulfonic acid group-containing monomers, phenylmaleimide-based monomer, or the like.

The amount of such an electric charge controlling agent to be blended is generally in the range of from a preferable lower limit of 0.1 to a preferable upper limit of 10 parts by weight, based on 100 parts by weight of a resin composition for toner.

Examples of the magnetic substance include a trade name “TAROX BL series” (manufactured by TITAN KOGYO KABUSHIKI KAISHA), a trade name “EPT series”, a trade name “MAT series”, a trade name “NTS series” (manufactured by TODA KOGYO CORP.), a trade name “DCM series” (manufactured by DOWA IRON POWDER CO., LTD), a trade name “KBC series”, a trade name “KBI series”, a trade name “KBF series”, a trade name “KBP series” (manufactured by KANTO DENKA KOGYO CO., LTD.), and a trade name “Bayoxide E series” (manufactured by Bayer AG).

For the conventional toners, when a magnetic substance is added, the ratio of the resin in the toner is lower than that in a non-magnetic toner, but by increasing the nip pressure of the fixation roller, there is a tendency that high temperature offset resistance is hardly exhibited. However, in the toner of the present invention, even when a magnetic substance is added, it is possible to exhibit good high temperature offset resistance. As such, one of the reasons why excellent high temperature offset resistance can be established even when a magnetic substance is added, is that in the resin composition for toners of the present invention, the isocyanate groups are highly dispersed in the resin, and at the same time, dispersed well in a releasing agent having polar groups added to the toner.

Thus, the resin composition of the present invention can be applied in all the toners, sine it can exhibit good high temperature offset resistance in a magnetic one-component toner that is considered to have a lowest ratio of the resin in the toner, among the usually used toners.

Examples of the rubber polymer include a natural rubber, a synthetic rubber such as a polyisoprene rubber, a polybutadiene rubber, a nitrile rubber (an acrylonitrile-butadiene copolymer), a chloroprene rubber, a butyl rubber, an acrylic rubber, a polyurethane elastomer, a silicone rubber, an ethylene-propylene copolymer, an ethylene-propylene-diene copolymer, a chlorosulfinated polyethylene, an ethylene vinyl acetate copolymer, an ethylene-acrylic copolymer, an ethylene-acrylate copolymer, chlorinated polyethylene, an epichlorohydrin rubber, and a nitrile isoprene rubber, an elastomer such as a polyester elastomer and an urethane elastomer, a block copolymer of an aromatic hydrocarbon with a conjugated diene-based hydrocarbon such as a styrene-butadiene-styrene block copolymer, a styrene-isoprene-styrene block copolymer, a styrene-ethylene-butylene-styrene block copolymer, and a styrene-ethylene-propylene-styrene block copolymer. In a block copolymer, a styrene-butadiene block copolymer or a styrene-isoprene block copolymer may be blended, as well as a hydrogenated product thereof.

Furthermore, a rubber polymer including an aromatic hydrocarbon having a polar group such as a hydroxyl group, a carboxyl group, an aldehyde group, a sulfonyl group, a cyano group, a nitro group, and halogen group at its terminal and a conjugated diene block copolymer is preferred, since it exhibits an excellent affinity with a toner. Such a block copolymer having a terminal polar group can be obtained by a living polymerization.

A rubber polymer can improve the resin strength of the resin contained in a toner. Accordingly, a toner containing a rubber polymer can prevent the filming phenomenon of the toner, and gives a toner suitable as a non-magnetic one-component toner which should have a high resin strength.

Example of the carrier include a metal element, alloy, oxide, ferrite of iron, nickel, copper, zinc, cobalt, manganese, chromium, and a rare-earth metal and the like. The carrier may have an oxidized surface. Further, the surface of a carrier maybe coated with a polytetrafluoroethylene, a monochlorotrifluoroethylene polymer, a polyvinylidene fluoride, a silicone polymer, a polyester, a di-tert-butylsalicylic acid metal complex, a styrene polymer, an acrylic polymer, a polyamide, a polyvinyl butyral, a nigrosine basic dye, silica powders, alumina powders and the like. By coating the carrier, a preferable frictional electrificating ability can be imparted to the carrier.

The cleaning performance-improving agent mentioned above is not particularly restricted as long as it can improve the fluidity of the toner when it is mixed with the toner. An increased fluidity of the toner serves to prevent the deposition of the toner on a cleaning blade. Example thereof include a fluorine-based polymer powder such as a vinylidene fluoride polymer, an acrylic polymer powder such as an acrylate polymer, a fatty acid metal salt powder such as zinc stearate, calcium stearate, and lead stearate, a metal oxide powder such as a zinc oxide powder and a titanium oxide powder, a microparticulate silica powder, a silica powder whose surface has been treated with a silane coupling agent or titanium coupling agent or a silicone oil, and fumed silica. Furthermore, as the cleaning performance-improving agent, spherical ones can be suitably used, that has a particle diameter of 0.05 to 0.5 μm, including an acryl-based polymer, a styrenic polymer and the like.

It is preferable that the toner of the present invention has a peak at a position corresponding to a weight average molecular weight of 2,000 or less, as measured by gel permeation chromatography. By this, fixability is improved. Furthermore, it is preferable that the toner of the present invention has a peak at a position corresponding to a weight average molecular weight of 10,000 or more, as measured by gel permeation chromatography. By this, water resistance is improved.

The particle diameter of the toner of the present invention is not particularly limited, but with the particle diameter of 5 μm or less, a particularly high image quality can be obtained.

The moisture content of the toner of the present invention is not particularly limited, but it is in the range of from a preferable lower limit of 0.01% by weight to a preferable upper limit of 0.2% by weight. With the moisture content of less than 0.01% by weight, it is difficult to prepare the toner in the preparation process, whereas with the moisture content of more than 0.2% by weight, sufficient charge stability may not be obtained.

The angle of repose of the toner of the present invention is not particularly limited, but the angle of repose at a temperature of 23° C. and a humidity of 60% is in the range of from a preferable lower limit of 1 degree to a preferable upper limit of 30 degrees. With the angle of repose of less than 1 degree, it is difficult to handle the toner, whereas with the angle of repose of more than 30 degrees, the flowability of the toner may be insufficient. The angle of repose of the toner can be measured, for example, by a powder tester (for example, PT-N Type, manufactured by Hosokawa Micron Group, etc.), etc.

The surface roughness of the toner of the present invention is not particularly limited, but it is in the range of from a preferable lower limit of 0.01 μm to a preferable upper limit of 2 μm. With the surface roughness of less than 0.01 μm, it may be difficult to carry out printing, whereas with the surface roughness of more than 2 μm, the surface gloss of the resulting image may be insufficient. The surface roughness can be measured by a method defined as a method for measuring an arithmetic average roughness (Ra) of a printed portion of the printed image using the toner of the present invention in accordance with JIS B 0601.

Since the toner of the present invention can exhibit good fixability over a wide range from a low temperature to a high temperature, whereby allowing a toner exhibiting the excellence with regard to all of the low temperature fixability, high temperature offset resistance, and anti-blocking performance. As a result, it can reduce the time period required for enabling the printing after the power is on, thereby providing an economical advantage, and it can also increase the speed of the printing because of its ability of maintaining the sharpness of an image even after the temperature of a roller is reduced. The toner of the present invention is excellent in image reproducibility.

While the toner according to the present invention may be fixed by a fixation roller coated with a release oil, it can exhibit good fixability even when the release oil is not coated on the fixation roller.

According to the present invention, a resin composition for toners which enables to obtain a toner having excellent low temperature fixability and high temperature offset resistance, a toner, and a method for preparing a resin composition for toners can be provided.

### BEST MODE FOR CARRYING OUT THE INVENTION

Hereinbelow, the present invention will be described in detail with reference to Examples, but the present invention is not limited thereto.

### Example 1

(1) Preparation of Branched Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of terephthalic acid as a dicarboxylic acid component, 5 moles of isophthalic acid as a bending monomers component, 5 moles of anhydrous phthalic acid, 2.5 moles of trimellitic acid as a tri- or higher-valent monomer, 100 moles of neopentyl glycol as a branched monomers component, 100 moles of ethylene glycol as another glycol, and 0.05 mole of titanium tetrabutoxide (TBB) as an esterification condensation catalyst, which were subjected to an esterification reaction while flowing the generated water out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a branched polyester. The hydroxyl value of the obtained branched polyester was measured to be 40.

(2) Preparation of Low Molecular Weight Linear Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of dimethyl terephthalate as a dicarboxylic acid component, 10 moles of dimethyl isophthalate as a bending monomers component, 100 moles of neopentyl glycol, 100 moles of ethylene glycol as another glycol, and 0.05 mole of titanium tetrabutoxide (TBB) as an esterification condensation catalyst, which were subjected to an esterification reaction while flowing the generated water and methanol out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a low molecular weight linear polyester. The hydroxyl value of the obtained low molecular weight linear polyester was measured to be 38.

(3) Preparation of Resin Composition for Toner

68.2 parts by weight of the obtained branched polyester and 29.3 parts by weight of the low molecular weight linear polyester were continuously fed to a twin screw extruder (manufactured by Ikegai Corporation, L/D=37) by a metering feeder, and melt kneaded at a barrel temperature of 120° C., and then a volatile fraction was removed from a first venting hole of the twin screw extruder.

Next, 2.5 parts by weight of polymeric MDI containing two or more isocyanate groups in one molecule (44V20, manufactured by Sumika Bayer Urethane Co., Ltd.) was continuously from a second venting hole of the twin screw extruder, and further melt kneaded at a barrel temperature of 170° C., thereby obtaining a resin composition for toners.

(4) Preparation of Toner

To 100 parts by weight of the obtained resin composition for toners, 1 part by weight of an electric charge controlling agent (S-34, manufactured by Orient Chemical Industries, Ltd.), 5 parts by weight of carbon black (MA-100, manufactured by Mitsubishi Chemical Corporation), and 3.5 parts by weight of carnauba wax (melting point: 83° C.) were thoroughly mixed using a Henschel mixed, melt kneaded at 130° C., cooled, and coarsely ground. Subsequently, this was finely divided using a jet mill (LABOJET, manufactured by Nippon Pneumatic Mfg. Co., Ltd.) to obtain a toner powder having a mean particle size of about 8 to 12 μm. Further, this toner powder was sieved with a sieving machine (MDS-2: manufactured by Nippon Pneumatic Mfg. Co., Ltd.) to obtain a toner fine powder having a mean particle size of about 10 μm. 100 parts by weight of this toner fine powder was uniformly mixed (treated externally) with 1.0 part by weight of a hydrophobic silica (R972: manufactured by Nippon Aerosil Co., Ltd.) to prepare a toner.

### Example 2

A resin composition for toners and a toner were prepared in a similar manner to Example 1, except that the amount of the branched polyester to be added was 39 parts by weight, the amount of the low molecular weight linear polyester to be added was 58. 5 parts by weight, and the amount of the polymeric MDI (44V20, manufactured by Sumika Bayer Urethane Co., Ltd.) to be added was 2.5 parts by weight in the preparation of the resin composition for toners.

### Comparative Example 1

A resin composition for toners and a toner were prepared in a similar manner to Example 1, except that the amount of the branched polyester to be added was 97.5 parts by weight, the amount of the low molecular weight linear polyester to be added was 0 part by weight, and the amount of the polymeric MDI (44V20, manufactured by Sumika Bayer Urethane Co., Ltd.) to be added was 2.5 parts by weight in the preparation of the resin composition for toners.

### Comparative Example 2

(1) Preparation of Low Molecular Weight Linear Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of dimethyl terephthalate as a dicarboxylic acid component, 10 moles of dimethyl isophthalate as a bending monomers component, 100 moles of neopentyl glycol, 100 moles of ethylene glycol as another glycol, and 0.05 mole of titanium tetrabutoxide (TBB) as an esterification condensation catalyst, which were subjected to an esterification reaction while flowing the generated water and methanol out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a polyester.

To the total amount of the obtained polyester, 13 moles of anhydrous trimellitic acid was added, and the mixture was subject to a reaction at 200° C. for about 1 hour, thereby obtaining a low molecular weight linear polyester. The acid value and the hydroxyl value of the low molecular weight linear polyester were measured to be 53 and 2, respectively.

Next, a resin composition for toners and a toner were prepared in a similar manner to Example 1, except that the amount of the branched polyester to be added was 68.2 parts by weight, the amount of the obtained low molecular weight linear polyester to be added was 29.3 parts by weight, and the amount of the polymeric MDI (44V20, manufactured by Sumika Bayer Urethane Co., Ltd.) to be added was 2.5 parts by weight in the preparation of the resin composition for toners.

(Evaluation)

The resin composition for toners and toner obtained in the resin composition for toners or the toner, prepared in Examples 1 and 2, and Comparative Examples 1 and 2, were evaluated by using the method as mentioned below. The results are shown in Table 1.

[Measurement of Molecular Weights of Polyester and Resin Composition for Toner]

As a GPC measurement device, HTR-C manufactured by Nihon Millipore Ltd. was employed, together with KF-800P (1 unit), KF-806M (2 units), and KF-802.5 (1 unit) manufactured by SHOWA DENKO K. K. as columns attached in a series to measure a weight average molecular weight (Mw) and a number average molecular weight (Mn). The measurement conditions involved a temperature of 40° C., a 0.2% by weight of a THF solution as a sample (filtered through 0.45 μm membrane), an injection volume of 100 μl, THF as a carrier solvent, and a standard polystyrene as a correction sample.

[Measurement of Glass Transition Temperature (Tg)]

For the resin composition for toners, a differential scanning calorimeter (DSC-6200R, manufactured by SEIKO INSTRUMENTS INC.) was used in the measurement at the temperature elevation rate of 10° C./minute in accordance with JIS K 7121, and the intermediate glass transition point specified in this standard (9.3 “Method for measuring glass transition point”) was determined.

[Measurement of Swelling Rate and THF Insoluble Fraction (Gel Fraction)]

0.3 g of the obtained resin composition for toners was metered into a sample bottle, 30 g of THF was added thereto, and the mixture was shaken at ambient temperature for 16 hours, and filtered through a 200-mesh metal wire filter. An insoluble fraction was washed out three times, and then the weight of the obtained residue (weight of swelled substance) was measured. Next, the obtained residue was dried at 110° C. for 1 hour, and then a weight after drying (weight of dried substance) was measured. From the weight of swelled substance and weight of dried substance, as obtained above, the following equations were used to determine a swelling rate and a THF insoluble fraction (gel fraction).

Swelling rate=(Weight of swelled substance/Weight of dried substance)×100

Tetrahydrofuran insoluble fraction(%)=(Weight of dried substance/Weight of sample)×100

[Measurement of Flow Softening Point]

Using a Kouka-shiki flow tester (CFT-500 type, manufactured by Shimadzu Corporation), under the condition of a load of 20 kg/cm², an orifice of 1 mmφ×1 mm, a preliminary temperature of 60° C., a preliminary time of 5 minutes, a chart speed of 20 mm/min, a plunger of 1.0 cm², and a temperature elevation rate of 6±0.5° C./min, a temperature, Tf, at which a median plunger descent rate h/2 is given in the plunger descent rate at a flow start point of a resin and the plunger descent rate at a flow end point of a resin, as shown in FIG. 1, by melt flowing 1.0 g of a measurement sample passing through a JIS standard sieve having a mesh size of 1.19 mm.

[Measurement of Relaxation Modulus]

The resin composition for toners was melted, and then formed it into a disc with a diameter of 25 mm and a height of 1 mm, to obtain a test sample. This was adhered to a disc-disc jig having a diameter: 25 mm, and by using a relaxation modulus measurement device (ARES, manufactured by TA Instruments), under the condition of a temperature of 170° C., a relaxation modulus G_{170° C.} (0.1) was measured at 0.1 second after a shear strain was applied to this under the condition of an initial shear strain of 450%.

[Evaluation of Blocking Property]

10 g of the toner was placed in a 100-mL sample bottle, which was allowed to stand in a thermostat chamber at 50° C. for 8 hours, and then a powder tester (produced by Hosokawa Micron Corporation) was employed to sieve the sample through a 250 μm filter, which was examined for any remaining aggregate, and when there was an aggregate then the weight (% by weight) of the aggregate based on the toner weight was calculated.

[Evaluation of Filming]

10,000 sheets were printed and the fixation roller was examined with naked eyes for any depositing tone, and when there was no toner deposition, the toner was judged as “Filming not observed”.

[Measurement of High Temperature Offset Temperature and Low Temperature Offset Temperature]

6.5 parts by weight of the toner obtained in each of Examples 1 and 2, and Comparative Examples 1 and 2 was combined with 93.5 parts by weight of the iron powder carrier having a mean particle size of 50 to 80 μm to produce a developing agent. As an electrophotographic copier, a UBIX4160AF manufactured by Konica Corporation which was modified so that the temperature of the heat fixation roller could be set as high as 250° C. at maximum was employed.

By changing the temperature setting of the heat fixation roller stepwise, a reproduced paper on which a non-fixed toner image had been fixed on a copy paper by the heat fixation roller at each temperature setting was obtained.

The resultant reproduced paper was examined visually for any toner dirt on the margin or fixed image, and the temperature range over which no dirt was found was designated as a non-offset temperature range. The maximum temperature of the non-offset temperature range was designated as a high temperature offset temperature, while the minimum was designated as a low temperature offset temperature.

[Measurement of Lowest Fixation Temperature of Toner]

The reproduction was conducted with changing the temperature setting of the heat fixation roller of the electrophotographic copying machine stepwise, and when there was no toner dirt on the margin or the fixed image with no fogging thereon and the reduction in density of the fixed image was less than 10% after rubbing the fixed image on the resultant reproduced paper with a cotton pad for a typewriter, then the fixation was judged to give a satisfactory result, the lowest temperature for which was measured.

The density of an image was obtained by using a MACHBETH photometer.

[Identification of Image Quality (Fogging Observed or not Observed, Image Density)]

In a similar manner to the test for measurement of the high temperature offset temperature and the low temperature offset temperature, an unfixed image was formed, an image at the 100^{th} sheet was fixed, and then the image quality (fogging observed or not observed) was identified with naked eyes. A level when there was no problem in generation of fogging was judged “Fogging not observed”, and a level where there is such problem is judged “Fogging observed”. Furthermore, the density of an image was obtained by using a MACHBETH photometer.

TABLE 1

| | | | | | Comparative | Comparative |
|---|---|---|---|---|---|---|
| | | | Example 1 | Example 2 | Example 1 | Example 2 |
| Branched polyester | Amount of raw material | Dimethyl Terephthalate | 90 | 90 | 90 | 90 |
| | monomers to be blended | Dimethyl isophthalate | 5 | 5 | 5 | 5 |
| | (moles) | Anhydrous phthalic acid | 5 | 5 | 5 | 5 |
| | | Trimellitic acid | 2.5 | 2.5 | 2.5 | 2.5 |
| | | Neopentyl glycol | 100 | 100 | 100 | 100 |
| | | Ethylene glycol | 100 | 100 | 100 | 100 |
| | Evaluation | Glass transition | 52 | 52 | 52 | 52 |
| | | temperature (° C.) | | | | |
| | | Weight average | 17000 | 17000 | 17000 | 17000 |
| | | molecular weight | | | | |
| | | Number average | 3100 | 3100 | 3100 | 3100 |
| | | molecular weight | | | | |
| | | Hydroxyl value | 40 | 40 | 40 | 40 |
| low molecular weight | Amount of raw material | Dimethyl terephthalate | 90 | 90 | — | 90 |
| linear polyester | monomers to be blended | Dimethyl isophthalate | 10 | 10 | — | 10 |
| | (moles) | Anhydrous trimellitic | — | — | — | 13 |
| | | acid | | | | |
| | | Neopentyl glycol | 100 | 100 | — | 100 |
| | | Ethylene glycol | 100 | 100 | — | 100 |
| | evaluation | Glass transition | 54 | 54 | — | 62 |
| | | temperature (° C.) | | | | |
| | | Weight average | 9400 | 9400 | — | 11200 |
| | | molecular weight | | | | |
| | | Number average | 4900 | 4900 | — | 3000 |
| | | molecular weight | | | | |
| | | Hydroxyl value | 38 | 38 | — | 3 |
| | | Acid value | 2 | 2 | — | 53 |
| Isocyanate compound | Kind | | polymeric | polymeric | polymeric | polymeric |
| | | | MDI (44V20) | MDI (MR200) | MDI (44V20) | MDI (44V20) |
| | Number of isocyanate groups in one molecule | | about 3 | about 3 | about 3 | about 3 |
| Resin composition for | Blended amount (parts by | Branched polyester | 68.2 | 39 | 97.5 | 68.2 |
| toner | weight) | Low molecular weight | 29.3 | 58.5 | 0 | 29.3 |
| | | linear polyester | | | | |
| | | Water content | 0.10 | 0.10 | 0.10 | 0.10 |
| | | (%) in polyester | | | | |
| | | Isocyanate compound | 2.5 | 2.5 | 2.5 | 2.5 |
| | Evaluation | Glass transition | 61 | 63 | 60 | 61 |
| | | temperature (° C.) | | | | |
| | | Weight average | 70000 | 40700 | 60700 | 57000 |
| | | molecular weight | | | | |
| | | Number average | 7700 | 7500 | 10600 | 9700 |
| | | molecular weight | | | | |
| | | Flow softening point | 144.6 | 125.8 | 163.6 | 139.0 |
| | | (° C.) | | | | |
| | | Relaxation modulus | 8.30 × 10² | 3.50 × 10² | 1.55 × 10³ | 5.50 × 10² |
| | | G170(0.1) (Pa) | | | | |
| | | THF insoluble | 6.1 | 4.4 | 7.8 | 5.2 |
| | | fraction (gel | | | | |
| | | fraction) | | | | |
| | | Swelling rate (%) | 3700 | 2000 | 5300 | 3100 |
| Toner | Blended amount (parts by | Resin composition for | 100 | 100 | 100 | 100 |
| | weight) | toner | | | | |
| | | Carbon black | 5 | 5 | 5 | 5 |
| | | (MA-100) | | | | |
| | | Electric charge | 1 | 1 | 1 | 1 |
| | | controlling agent | | | | |
| | | (S-34) | | | | |
| | | Release agent | 3.5 | 3.5 | 3.5 | 3.5 |
| | | | Carnauba | Carnauba | Carnauba | Carnauba |
| | Evaluation | Blocking (% by | 0.5 | 0.5 | 0.5 | 0.5 |
| | | weight) | | | | |
| | | Filming Evaluation | Not | Not | Not | Not |
| | | | observed | observed | observed | observed |
| | | High temperature | 240 | 220 | 240 or more | 230 |
| | | offset temperature | | | | |
| | | (° C.) | | | | |
| | | Low temperature | 145 | 125 | 160 | 140 |
| | | offset temperature | | | | |
| | | (° C.) | | | | |
| | | Lowest fixation | 140 | 120 | 155 | 135 |
| | | temperature (° C.) | | | | |
| | | Image quality (Image | 1.5 | 1.5 | 1.5 | 1.0 |
| | | density) | | | | |
| | | Image quality (Fogging | Not | Not | Not | Observed |
| | | observed or not observed) | observed | observed | observed | |

### Example 3

(1) Preparation of Branched Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of terephthalic acid as a dicarboxylic acid component, 5 moles of isophthalic acid as a bending monomers component, 5 moles of anhydrous phthalic acid, 2.5 moles of trimellitic acid as a tri- or higher-valent monomer, 100 moles of neopentyl glycol as a branched monomers component, 100 moles of ethylene glycol as another glycol, and 0.0.5 mole of titanium tetrabutoxide (TBB) as an esterification condensation catalyst, which were subjected to an esterification reaction while flowing the generated water out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flowing out of the reaction system, thereby obtaining a branched polyester.

(2) Preparation of Low Molecular Weight Linear Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of dimethyl terephthalate as a dicarboxylic acid component, 10 moles of dimethyl isophthalate as a bending monomers component, 100 moles of neopentyl glycol, 100 moles of ethylene glycol as another glycol, and 0.05 mole of titanium tetrabutoxide (TBB) as an esterification condensation catalyst, which were subjected to an esterification reaction while flowing the generated water and methanol out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a low molecular weight linear polyester. The hydroxyl value of the obtained low molecular weight linear polyester was measured to be 38.

(3) Preparation of Resin Composition for Toner

92.5 parts by weight of the obtained branched polyester and 5.0 parts by weight of the low molecular weight linear polyester were continuously fed to a twin screw extruder (manufactured by Ikegai Corporation, L/D=37) by a metering feeder, and melt kneaded at a barrel temperature of 120° C., and then a volatile fraction was removed from a first venting hole of the twin screw extruder.

Next, 2.5 parts by weight of polymeric MDI containing two or more isocyanate groups in one molecule (44V20, manufactured by Sumika Bayer Urethane Co., Ltd.) was continuously from a second venting hole of the twin screw extruder, and further melt kneaded at a barrel temperature of 170° C., thereby obtaining a resin composition for toners.

(4) Preparation of Toner

To 100 parts by weight of the obtained resin composition for toners, 1 part by weight of an electric charge controlling agent (S-34, manufactured by Orient Chemical Industries, Ltd.), 5 parts by weight of carbon black (MA-100, manufactured by Mitsubishi Chemical Corporation), and 3.5 parts by weight of carnauba wax (melting point: 83° C.) were thoroughly mixed using a Henschel mixed, melt kneaded at 130° C., cooled, and coarsely ground. Subsequently, this was finely divided using a jet mill (LABOJET, manufactured by Nippon Pneumatic Mfg. Co., Ltd.) to obtain a toner powder having a mean particle size of about 8 to 12 μm. Further, this toner powder was sieved with a sieving machine (MDS-2: manufactured by Nippon Pneumatic Mfg. Co., Ltd.) to obtain a toner fine powder having a mean particle size of about 10 μm. 100 parts by weight of this toner fine powder was uniformly mixed (treated externally) with 1.0 part by weight of a hydrophobic silica (R972: manufactured by Nippon Aerosil Co., Ltd.) to prepare a toner.

### Example 4

(1) Preparation of Branched Polyester

A branched polyester was obtained in the same manner as in Example 3.

(2) Preparation of Low Molecular Weight Linear Polyester

A low molecular weight linear polyester was obtained in the same manner as in Example 3.

(3) Preparation of Resin Composition for Toner

A resin composition for toners was obtained in the same manner as in Example 3, except that the amount of the obtained branched polyester to be added was 92.5 parts by weight, the amount of the low molecular weight linear polyester to be added was 5.0 parts by weight, and the amount of the polymeric MDI (44V20, manufactured by Sumika Bayer Urethane Co., Ltd.) to be added was 2.1 parts by weight.

(4) Preparation of Toner

A toner was prepared using the obtained resin composition for toners in the same manner as in Example 3.

### Example 5

(1) Preparation of Branched Polyester

A branched polyester was obtained in the same manner as in Example 3, except that the amount of trimellitic acid to be added was 4.3 moles.

(2) Preparation of Low Molecular Weight Linear Polyester

A low molecular weight linear polyester was obtained in the same manner as in Example 3.

(3) Preparation of Resin Composition for Toner

A resin composition for toners was obtained in the same manner as in Example 3, except that the amount of the obtained branched polyester to be added was 70.0 parts by weight, the amount of the low molecular weight linear polyester to be added was 27.5 parts by weight, and the amount of the polymeric MDI (44V20, manufactured by Sumika Bayer Urethane Co., Ltd.) to be added was 1.5 parts by weight.

(4) Preparation of Toner

A toner was prepared using the obtained resin composition for toners in the same manner as in Example 3.

### Example 6

(1) Preparation of Branched Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of terephthalic acid as a dicarboxylic acid component, 5 moles of isophthalic acid as a bending monomers component, 5 moles of anhydrous phthalic acid, 2.5 moles of trimellitic acid as a tri- or higher-valent monomer, 100 moles of neopentyl glycol as a branched monomers component, 100 moles of ethylene glycol as another glycol, and 0.05 mole of titanium tetrabutoxide (TBB) as an esterification condensation catalyst, which were subjected to an esterification reaction while flowing the generated water out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a branched polyester.

(2) Preparation of Low Molecular Weight Linear Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of dimethyl terephthalate as a dicarboxylic acid component, 10 moles of dimethyl isophthalate as a bending monomers component, 100 moles of neopentyl glycol, 100 moles of ethylene glycol as another glycol, and 0.05 mole of titanium tetrabutoxide (TBB) as an esterification condensation catalyst, which were subjected to an esterification reaction while flowing the generated water and methanol out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a low molecular weight linear polyester. The hydroxyl value of the obtained low molecular weight linear polyester was measured to be 38.

(3) Preparation of Resin Composition for Toner

70.0 parts by weight of the obtained branched polyester and 27.5 parts by weight of the low molecular weight linear polyester were continuously fed to a twin screw extruder (manufactured by Ikegai Corporation, L/D=37) by a metering feeder, and melt kneaded at a barrel temperature of 120° C., and then a volatile fraction was removed from a first venting hole of the twin screw extruder.

Next, 1.8 parts by weight of polymeric MDI containing two or more isocyanate groups in one molecule (44V20, manufactured by Sumika Bayer Urethane Co., Ltd.) was continuously from a second venting hole of the twin screw extruder, and further melt kneaded at a barrel temperature of 170° C., thereby obtaining a resin composition for toners.

(4) Preparation of Toner

To 100 parts by weight of the obtained resin composition for toners, 1 part by weight of an electric charge controlling agent (S-34, manufactured by Orient Chemical Industries, Ltd.), 5 parts by weight of carbon black (MA-100, manufactured by Mitsubishi Chemical Corporation), and 3.5 parts by weight of carnauba wax (melting point 83° C.) were thoroughly mixed using a Henschel mixed, melt kneaded at 130° C., cooled, and coarsely ground. Subsequently, this was finely divided using a jet mill (LABOJET, manufactured by Nippon Pneumatic Mfg. Co., Ltd.) to obtain a toner powder having a mean particle size of about 8 to 12 μm. Further, this toner powder was sieved with a sieving machine (MDS-2: manufactured by Nippon Pneumatic Mfg. Co., Ltd.) to obtain a toner fine powder having a mean particle size of about 10 μm. 100 parts by weight of this toner fine powder was uniformly mixed (treated externally) with 1.0 part by weight of a hydrophobic silica (R972: manufactured by Nippon Aerosil Co., Ltd.) to prepare a toner.

A toner was prepared using the obtained resin composition for toners in the same manner as in Example 6.

### Comparative Example 3

(1) Preparation of Branched Polyester

A branched polyester was obtained in the same manner as in Example 3, except that the amount of trimellitic acid to be added was 4.7 moles, the amount of neopentyl glycol as a branched monomers component to be added was 45 moles, and the amount of ethylene glycol as another glycol to be added was 45 moles.

(2) Preparation of Low Molecular Weight Linear Polyester

A low molecular weight linear polyester was obtained in the same manner as in Example 3.

(3) Preparation of Resin Composition for Toner

A resin composition for toners was obtained in the same manner as in Example 3, except that the amount of the obtained branched polyester to be added was 70.0 parts by weight, the amount of the low molecular weight linear polyester to be added was 27.5 parts by weight, and the amount of the polymeric MDI (44V20, manufactured by Sumika Bayer Urethane Co., Ltd.) to be added was 5.2 parts by weight.

(4) Preparation of Toner

A toner was prepared using the obtained resin composition for toners in the same manner as in Example 3.

### Comparative Example 4

(1) Preparation of Linear Chained Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of terephthalic acid as a dicarboxylic acid component, isophthalic acid as a bending monomers component 10 moles, 100 moles of neopentyl glycol as a branched monomers component, 100 moles of ethylene glycol as another glycol, and 0.05 mole of titanium tetrabutoxide (TBB) as an esterification condensation catalyst, which were subjected to an esterification reaction while flowing the generated water out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a linear chained polyester.

(2) Preparation of Resin Composition for Toner

A resin composition for toners was obtained in the same manner as in Example 3, except that the amount of the obtained linear chained polyester to be added was 96.3 parts by weight, and the amount of the polymeric MDI (44V20, manufactured by Sumika Bayer Urethane Co., Ltd.) to be added was 3.7 parts by weight.

(3) Preparation of Toner

A toner was prepared using the obtained resin composition for toners in the same manner as in Example 3.

### Comparative Example 5

(1) Preparation of Branched Polyester

A branched polyester was obtained in the same manner as in Example 3, except that the amount of trimellitic acid to be added was 5.9 moles.

(2) Preparation of Low Molecular Weight Linear Polyester

A low molecular weight linear polyester was obtained in the same manner as in Example 3.

(3) Preparation of Resin Composition for Toner

A resin composition for toners was obtained in the same manner as in Example 3, except that the amount of the obtained branched polyester to be added was 92.5 parts by weight, the amount of the low molecular weight linear polyester to be added was 5.0 parts by weight, and the amount of the polymeric MDI (44V20, manufactured by Sumika Bayer Urethane Co., Ltd.) to be added was 1.5 parts by weight.

(4) Preparation of Toner

A toner was prepared using the obtained resin composition for toners in the same manner as in Example 3.

(Evaluation)

Measurement of the molecular weight distribution, the glass transition temperature, the flow softening point, the relaxation modulus, the high temperature offset temperature, and the low temperature offset temperature of the polyester and the resin composition for toners, and the lowest fixation temperature of the toner, as well as evaluation of blocking property, filming, and image quality (fogging observed or not observed, image density) were conducted on the branched polyester, the resin composition for toners, or the toner, prepared in each of Examples 3 to 6, and Comparative Examples 3 to 5, in the same manner as in Examples 1 and 2, and Comparative Examples 1 and 2. Furthermore, evaluation was conducted in the following method. The results are shown in Table 2.

[Measurement of Hydroxyl Value of Branched Polyester]

The hydroxyl value of the obtained branched polyester was determined in accordance with JIS K 0070.

[Measurement of Acid Value of Branched Polyester]

The acid value of the obtained branched polyester was determined in accordance with JIS K 6751, except that tetrahydrofuran (THF) was used instead of ethyl alcohol.

[Determination of Average Branching Degree]

The average branching degree of the branched polyester was determined from the hydroxyl value (OHV) and the number average molecular weight (Mn) of the branched polyester that had been determined as above.

[Measurement of Area Ratio]

After measuring the molecular weight distribution of the branched polyester as described above, using the molecular weight distribution curve of the obtained branched polyester, the total peak area (A region) of the branched polyester before reaction was determined. Then, the peak area (B region) in the range corresponding to the molecular weights that are no more than the peak molecular weight of the branched polyester before reaction in the obtained resin composition for toners was determined, as described above. Using these areas, the area ratio of the pear area in the range corresponding to the molecular weights that are not more than the peak molecular weight of the branched polyester to the total peak area was determined.

[Measurement of Water Content]

The water content of the obtained branched polyester was determined by a method in accordance with JIS K 7251.

TABLE 2

| | | | Example 3 | Example 4 | Example 5 | Example 6 |
|---|---|---|---|---|---|---|
| Branched polyester | Amount of raw material | Terephthalic acid | 90 | 90 | 90 | 90 |
| | monomers to be blended | Isophthalic acid | 5 | 5 | 5 | 5 |
| | (moles) | Anhydrous phthalic acid | 5 | 5 | 5 | 5 |
| | | Trimellitic acid | 2.5 | 2.5 | 4.3 | 2.5 |
| | | Neopentyl glycol | 100 | 100 | 100 | 100 |
| | | Ethylene glycol | 100 | 100 | 100 | 100 |
| | Evaluation | Glass transition | 52 | 52 | 57 | 52 |
| | | temperature (° C.) | | | | |
| | | Weight average | 17000 | 17000 | 18000 | 17000 |
| | | molecular weight | | | | |
| | | Number average | 3100 | 3100 | 3100 | 3100 |
| | | molecular weight | | | | |
| | | Peak molecular | 8900 | 8900 | 5000 | 8900 |
| | | weight | | | | |
| | | Hydroxyl value | 40 | 40 | 74 | 40 |
| | | Acid value | 3 | 3 | 4 | 3 |
| | | Average branching | 2.2 | 2.2 | 4.1 | 2.2 |
| | | degree | | | | |
| Low molecular weight | Amount of raw material | Dimethyl terephthalate | 90 | 90 | 90 | 90 |
| linear polyester | monomers to be blended | Dimethyl isophthalate | 10 | 10 | 10 | 10 |
| | (moles) | Anhydrous trimellitic | — | — | — | — |
| | | acid | | | | |
| | | Neopentyl glycol | 100 | 100 | 100 | 100 |
| | | Ethylene glycol | 100 | 100 | 100 | 100 |
| | Evaluation | Glass transition | 54 | 54 | 54 | 54 |
| | | temperature (° C.) | | | | |
| | | Weight average | 9400 | 9400 | 9400 | 9400 |
| | | molecular weight | | | | |
| | | Number average | 4900 | 4900 | 4900 | 4900 |
| | | molecular weight | | | | |
| | | Hydroxyl value | 38 | 38 | 38 | 38 |
| | | Acid value | 2 | 2 | 2 | 2 |
| Isocyanate compound | Kind | | Polymeric | Polymeric | polymeric | Polymeric |
| | | | MDI (44V20) | MDI (44V20) | MDI (MR200) | MDI (44V20) |
| | The number of isocyanate groups in one molecule | | about 3 | about 3 | about 3 | about 3 |
| Resin composition for | Blended amount (parts by | Branched polyester | 92.5 | 92.5 | 70.0 | 70.0 |
| toner | weight) | Low molecular weight | 5.0 | 5.0 | 27.5 | 27.5 |
| | | linear polyester | | | | |
| | | Water content | 0.08 | 0.08 | 0.07 | 0.08 |
| | | (%) in polyester | | | | |
| | | Isocyanate compound | 2.5 | 2.1 | 1.5 | 1.8 |
| | Evaluation | Glass transition | 65 | 63 | 62 | 61 |
| | | temperature (° C.) | | | | |
| | | Weight average | 142100 | 134000 | 29900 | 79500 |
| | | molecular weight | | | | |
| | | Number average | 4900 | 4600 | 3100 | 4400 |
| | | molecular weight | | | | |
| | | Flow softening | 148 | 136.8 | 148.2 | 128.4 |
| | | point (° C.) | | | | |
| | | Relaxation modulus | 8.50 × 10² | 6.00 × 10² | 3.91 × 10² | 2.45 × 10² |
| | | D170(0.1) (Pa) | | | | |
| | | area ratio(%) | 24 | 33 | 40 | — |
| toner | Blended amount (parts by | Resin composition for | 100 | 100 | 100 | 100 |
| | weight) | toner | | | | |
| | | Carbon black | 5 | 5 | 5 | 5 |
| | | (MA-100) | | | | |
| | | Electric charge | 1 | 1 | 1 | 1 |
| | | controlling agent | | | | |
| | | (S-34) | | | | |
| | | Releasing | 3.5 | 3.5 | 3.5 | 3.5 |
| | | agent | carnauba | carnauba | carnauba | carnauba |
| | Evaluation | Blocking (% by | 0.5 | 0.5 | 0.5 | 0.5 |
| | | weight) | | | | |
| | | Evaluation of | Not | Not | Not | Not |
| | | filming | observed | observed | observed | observed |
| | | High temperature offset | 240 | 240 | 220 | 200 |
| | | temperature (° C.) | | | | |
| | | Low temperature offset | 145 | 130 | 145 | 120 |
| | | temperature (° C.) | | | | |
| | | Lowest fixation | 145 | 135 | 145 | 125 |
| | | temperature (° C.) | | | | |
| | | Image quality | 1.5 | 1.5 | 1.5 | 1.5 |
| | | (Image density) | | | | |
| | | Image quality (Fogging | Not | Not | Not | Not |
| | | observed or not observed) | observed | observed | observed | observed |

| | | | Comparative | Comparative | Comparative |
|---|---|---|---|---|---|
| | | | Example 3 | Example 4 | Example 5 |
| Branched polyester | Amount of raw material | Terephthalic acid | 90 | 90 | 90 |
| | monomers to be blended | Isophthalic acid | 5 | 10 | 5 |
| | (moles) | Anhydrous phthalic | 5 | — | 5 |
| | | acid | | | |
| | | Trimellitic acid | 4.7 | — | 5.9 |
| | | Neopentyl glycol | 45 | 100 | 100 |
| | | Ethylene glycol | 45 | 100 | 100 |
| | Evaluation | Glass transition | 65 | 57 | 62 |
| | | temperature (° C.) | | | |
| | | Weight average | 11000 | 12000 | 23000 |
| | | molecular weight | | | |
| | | Number average | 5100 | 6200 | 4200 |
| | | molecular weight | | | |
| | | Peak molecular | 8700 | 11000 | 6800 |
| | | weight | | | |
| | | Hydroxyl value | 3 | 18 | 105 |
| | | Acid value | 46 | 3 | 3 |
| | | Average branching | 2.0 | 2.0 | 7.9 |
| | | degree | | | |
| Low molecular weight | Amount of raw material | Dimethyl terephthalate | 90 | — | 90 |
| linear polyester | monomers to be blended | Dimethyl isophthalate | 10 | — | 10 |
| | (moles) | Anhydrous trimellitic | — | — | — |
| | | acid | | | |
| | | Neopentyl glycol | 100 | — | 100 |
| | | Ethylene glycol | 100 | — | 100 |
| | Evaluation | Glass transition | 54 | — | 54 |
| | | temperature (° C.) | | | |
| | | Weight average | 9400 | — | 9400 |
| | | molecular weight | | | |
| | | Number average | 4900 | — | 4900 |
| | | molecular weight | | | |
| | | Hydroxyl value | 38 | — | 38 |
| | | Acid value | 2 | — | 2 |
| Isocyanate compound | Kind | | Polymeric | Polymeric | Polymeric |
| | | | MDI (44V20) | MDI (44V20) | MDI (44V20) |
| | The number of isocyanate groups in one molecule | | about 3 | about 3 | about 3 |
| Resin composition for | Blended amount (parts by | Branched polyester | 70.0 | 100.0 | 92.5 |
| toner | weight) | Low molecular weight | 27.5 | 0 | 5.0 |
| | | linear polyester | | | |
| | | Water content | 0.08 | 0.08 | 0.07 |
| | | (%) in polyester | | | |
| | | Isocyanate compound | 5.2 | 3.7 | 1.5 |
| | Evaluation | Glass transition | 68 | 62 | 66 |
| | | temperature (° C.) | | | |
| | | Weight average | 10200 | 31600 | 155000 |
| | | molecular weight | | | |
| | | Number average | 2800 | 4800 | 7600 |
| | | molecular weight | | | |
| | | Flow softening | 115.3 | 120.5 | 162.0 |
| | | point (° C.) | | | |
| | | Relaxation modulus | 3.16 × 10 | 2.67 × 10 | 9.66 × 10² |
| | | D170(0.1) (Pa) | | | |
| | | area ratio(%) | 61 | 50 | 18 |
| toner | Blended amount (parts by | Resin composition for | 100 | 100 | 100 |
| | weight) | toner | | | |
| | | Carbon black | 5 | 5 | 5 |
| | | (MA-100) | | | |
| | | Electric charge | 1 | 1 | 1 |
| | | controlling agent | | | |
| | | (S-34) | | | |
| | | Releasing | 3.5 | 3.5 | 3.5 |
| | | agent | carnauba | carnauba | carnauba |
| | Evaluation | Blocking (% by | 0.5 | 0.5 | 0.5 |
| | | weight) | | | |
| | | Evaluation of | Not | Not | Not |
| | | filming | observed | observed | observed |
| | | High temperature offset | 120 | 120 | 240 |
| | | temperature (° C.) | | | |
| | | Low temperature offset | 110 | 110 | 155 |
| | | temperature (° C.) | | | |
| | | Lowest fixation | 110 | 110 | 155 |
| | | temperature (° C.) | | | |
| | | Image quality | 1.5 | 1.5 | 1.5 |
| | | (Image density) | | | |
| | | Image quality (Fogging | Not | Not | Not |
| | | observed or not observed) | observed | observed | observed |

### Example 7

(1) Preparation of Branched Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of terephthalic acid as a carboxylic acid component, 5 moles of isophthalic acid, 5 moles of anhydrous phthalic acid, 2.5 moles of trimellitic acid, 100 moles of neopentyl glycol as a diol component, 100 moles of ethylene glycol, and 0.05 mole of titanium tetrabutoxide (TBB) as a catalyst, which were subjected to an esterification reaction while flowing the generated water out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 Torr or less, and conducting the condensation reaction with stirring at 60 rpm at 240° C., while the free diol generated in the condensation reaction was allowed to flow out of the reaction system, thereby obtaining a branched polyester.

The hydroxyl value of the obtained branched polyester was measured to be 40.

(2) Preparation of Low Molecular Weight Linear Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of dimethyl terephthalate as a dicarboxylic acid component, 10 moles of dimethyl isophthalate as a bending monomers component, 100 moles of neopentyl glycol, 100 moles of ethylene glycol as another glycol, and 0.05 mole of titanium tetrabutoxide (TBB) as an esterification condensation catalyst, which were subjected to an esterification reaction while flowing the generated water and methanol out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a low molecular weight linear polyester. The hydroxyl value of the obtained low molecular weight linear polyester was measured to be 38.

(3) Preparation of Resin Composition for Toner

60.0 parts by weight of the obtained branched polyester and 38.0 parts by weight of the low molecular weight linear polyester were continuously fed to a twin screw extruder (manufactured by Ikegai Corporation, L/D=37) by a metering feeder, and melt kneaded at a barrel temperature of 160° C., and then a volatile fraction was removed from a venting hole of the twin screw extruder at atmospheric pressure.

At that time, the temperature of the branched polyester and the low molecular weight linear polyester were at 160° C. 2.0 parts by weight of polymeric MDI containing two or more isocyanate groups in one molecule (44V20, manufactured by Sumika Bayer Urethane Co., Ltd.) was continuously from an addition part, and further melt kneaded at a barrel temperature of 170° C., thereby obtaining a resin composition for toners.

(4) Measurement of Water Content

The obtained branched polyester and low molecular weight linear polyester were continuously fed to a twin screw extruding kneader (manufactured by Ikegai Corporation, L/D=37), and melt kneaded at a barrel temperature of 160° C., and then moisture was removed from a venting hole of the twin screw extruder under atmospheric pressure. Thereafter, the residue was melt kneaded without addition of an isocyanate compound.

The kneaded branched polyester and low molecular weight linear polyester were cooled, ground, and passed through as a 100-mesh sieve, to obtain branched polyester and low molecular weight linear polyester before drying. 3 g of the obtained branched polyester and low molecular weight linear polyester before drying were weighed, carried on an aluminum tray, dried in a gear oven at 110° C. for 3 hours, to obtain a branched polyester and low molecular weight linear polyester after drying.

The water content of the branched polyester and low molecular weight linear polyester before reaction, is represented by the following equation (2). The water content of the branched polyester and low molecular weight linear polyester before reaction can be considered to be substantially equivalent to that of the branched polyester and low molecular weight linear polyester upon addition of the isocyanate compound.

[Equation 2]

Water content (% by weight)=[(Weight of branched polyester before drying)−(Weight of branched polyester after drying)]/(Weight of branched polyester before drying)×100 (2)

The water content of the obtained branched polyester and low molecular weight linear polyester before reaction was determined to be 0.3% by weight.

(5) Preparation of Toner

To 100 parts by weight of the obtained resin composition for toners, 1 part by weight of an electric charge controlling agent (S-34, manufactured by Orient Chemical Industries, Ltd.), 5 parts by weight of carbon black (MA-100, manufactured by Mitsubishi Chemical Corporation), and 3.5 parts by weight of carnauba wax (melting point 83° C.) were thoroughly mixed using a Henschel mixed, melt kneaded at 130° C., cooled, and coarsely ground. Subsequently, this was finely divided using a jet mill (LABOJET, manufactured by Nippon Pneumatic Mfg. Co., Ltd.) to obtain a toner powder having a mean particle size of about 8 to 12 μm. Further, this toner powder was sieved with a sieving machine (MDS-2: manufactured by Nippon Pneumatic Mfg. Co., Ltd.) to obtain a toner fine powder having a mean particle size of about 10 μm. 100 parts by weight of this toner fine powder was uniformly mixed (treated externally) with 1.0 part by weight of a hydrophobic silica (R972: manufactured by Nippon Aerosil Co., Ltd.) to prepare a toner.

### Example 8

(1) Preparation of Resin Composition for Toners and Toner

A resin composition for toners and a toner were prepared in a similar manner to Example 7, except that the opening part is a vacuum venting hole, and moisture was removed under a pressure reduced to 100 Torr.

(2) Measurement of Water Content

The water content of the branched polyester and low molecular weight linear polyester before reaction were found to be 0.1% by weight, as determined in the same manner as in Example 7, except that the branched polyester and the low molecular weight linear polyester were continuously fed to a twin screw extruding kneader (manufactured by Ikegai Corporation, L/D=37), and melt kneaded at a barrel temperature of 160° C., and then moisture was removed from a vacuum venting hole of the twin screw extruder under a pressure reduced to 100 Torr, and then an isocyanate compound was not added thereto.

### Comparative Example 6

(1) Preparation of Resin Composition for Toners and Toner

A resin composition for toners and a toner were prepared in the same manner as in Example 7, except that the venting hole was closed, and moisture was not removed from the branched polyester and the low molecular weight linear polyester.

(2) Measurement of Water Content

The water content of the branched polyester and low molecular weight linear polyester before reaction were found to be 0.6% by weight, as determined in the same manner as in Example 7, except that the branched polyester and the low molecular weight linear polyester were continuously fed to a twin screw extruding kneader (manufactured by Ikegai Corporation, L/D=37), and melt kneaded at a barrel temperature of 160° C., and then moisture was removed from a vacuum venting hole of the twin screw extruder under a pressure reduced to 100 Torr, and then the isocyanate compound was not added thereto.

(Evaluation)

Measurement of the molecular weight distribution, the glass transition temperature, the flow softening point, the relaxation modulus, the high temperature offset temperature, and the low temperature offset temperature of the polyester and the resin composition for toners, and the lowest fixation temperature of the toner, as well as evaluation of blocking property, filming, and image quality (fogging observed or not observed, image density) were conducted on the resin composition for toners or the toner, prepared in each of Examples 7 and 8, and Comparative Example 6, in the same manner as in Examples 1 and 2, and Comparative Examples 1 and 2. Furthermore, evaluation was conducted in the following method. The results are shown in Table 3.

TABLE 3

| | | | | | Comparative |
|---|---|---|---|---|---|
| | | | Example 7 | Example 8 | Example 6 |
| Branched polyester | Amount of raw material | Dimethyl terephthalate | 90 | 90 | 90 |
| | monomers to be blended | Dimethyl isophthalate | 5 | 5 | 5 |
| | (moles) | Anhydrous phthalic acid | 5 | 5 | 5 |
| | | Trimellitic acid | 2.5 | 2.5 | 2.5 |
| | | Neopentyl glycol | 100 | 100 | 100 |
| | | Ethylene glycol | 100 | 100 | 100 |
| | Evaluation | Glass transition | 52 | 52 | 52 |
| | | temperature (° C.) | | | |
| | | Weight average | 17000 | 17000 | 17000 |
| | | molecular weight | | | |
| | | Number average | 3100 | 3100 | 3100 |
| | | molecular weight | | | |
| | | Hydroxyl value | 40 | 40 | 40 |
| Low molecular weight | Amount of raw material | Dimethyl terephthalate | 90 | 90 | 90 |
| linear polyester | monomers to be blended | Dimethyl isophthalate | 10 | 10 | 10 |
| | (moles) | Anhydrous trimellitic | — | — | — |
| | | acid | | | |
| | | Neopentyl glycol | 100 | 100 | 100 |
| | | Ethylene glycol | 100 | 100 | 100 |
| | Evaluation | Glass transition | 54 | 54 | 54 |
| | | temperature (° C.) | | | |
| | | Weight average | 9400 | 9400 | 9400 |
| | | molecular weight | | | |
| | | Number average | 4900 | 4900 | 4900 |
| | | molecular weight | | | |
| | | Hydroxyl value | 38 | 38 | 38 |
| | | Acid value | 2 | 2 | 2 |
| Isocyanate compound | Kind | | Polymeric | Polymeric | Polymeric |
| | | | MDI (44V20) | MDI (44V20) | MDI (44V20) |
| | The number of isocyanate groups in one molecule | | about 3 | about 3 | about 3 |
| Process for removal of moisture | | Observed or not | Observed | Observed | Not |
| | | observed | | | observed |
| | | Pressure | Atmospheric | 100 Torr | — |
| | | | pressure | | |
| Resin composition for | Blended amount (parts by | Branched polyester | 60.0 | 60.0 | 60.0 |
| toner | weight) | Low molecular weight | 38.0 | 38.0 | 38.0 |
| | | linear polyester | | | |
| | | Isocyanate compound | 2.0 | 2.0 | 2.0 |
| | Evaluation | Water content (% by | 0.3 | 0.1 | 0.6 |
| | | weight) | | | |
| | | Glass transition | 63 | 66 | 56 |
| | | temperature (° C.) | | | |
| | | Weight average | 52000 | 64000 | 25000 |
| | | molecular weight | | | |
| | | Number average | 5800 | 6700 | 2900 |
| | | molecular weight | | | |
| | | Flow softening point | 128 | 130 | 116 |
| | | (° C.) | | | |
| | | Relaxation modulus | 5.8 × 10² | 7.2 × 10² | 0.9 × 10² |
| | | G_{170° C.} (0.1) (Pa) | | | |
| toner | Blended amount (parts by | Resin composition for | 100 | 100 | 100 |
| | weight) | toner | | | |
| | | Carbon black | 5 | 5 | 5 |
| | | (MA-100) | | | |
| | | Electric charge | 1 | 1 | 1 |
| | | controlling agent | | | |
| | | (S-34) | | | |
| | | Releasing | 3.5 | 3.5 | 3.5 |
| | | agent | Carnauba | Carnauba | Carnauba |
| | Evaluation | High temperature offset | 230 | 245 | 150 |
| | | temperature (° C.) | | | |
| | | Low temperature offset | 120 | 120 | 120 |
| | | temperature (° C.) | | | |
| | | Lowest fixation | 125 | 125 | 130 |
| | | temperature (° C.) | | | |
| | | Image quality (Fogging | Not | Not | Observed |
| | | observed or not observed) | observed | observed | |

### Example 9

(1) Preparation of Branched Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of Terephthalic acid as a dicarboxylic acid component, 5 moles of isophthalic acid as a bending monomers component, 5 moles of anhydrous phthalic acid, 2.5 moles of trimellitic acid as a tri- or higher-valent monomer, 100 moles of neopentyl glycol as a branched monomers component, 100 moles of ethylene glycol as another glycol, and 0.05 mole of titanium tetrabutoxide (TBB) as an esterification condensation catalyst, which were subjected to an esterification reaction while flowing the generated water out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a branched polyester. The hydroxyl value of the obtained branched polyester was measured to be 40.

(2) Preparation of Low Molecular Weight Linear Polyester

A 60-L reaction container was fitted with a distillation tower, a water separator, a nitrogen gas inlet tube, a thermometer, and a stirrer in an ordinary manner, and charged in a nitrogen gas atmosphere with 90 moles of dimethyl terephthalate as a dicarboxylic acid component, 10 moles of dimethyl isophthalate as a bending monomers component, 100 moles of neopentyl glycol, 100 moles of ethylene glycol as another glycol, and 0.05 mole of titanium tetrabutoxide (TBB) as an esterification condensation catalyst, which were subjected to an esterification reaction while flowing the generated water and methanol out via the distillation tower at 200° C. At the time when no water was flowed out via the distillation tower, the esterification reaction was terminated.

After terminating the esterification reaction, the opening part of the 60-L reaction container communicating with the distillation tower was closed, and the line to the vacuum pump was opened, thereby reducing the pressure of the reaction system to 5 mmHg or less, and conducting the condensation reaction with stirring at 60 rpm at 240° C., while the free diol generated in the condensation reaction was allowed to flow out of the reaction system, thereby obtaining a low molecular weight linear polyester. The hydroxyl value of the obtained low molecular weight linear polyester was measured to be 38.

(3) Preparation of Resin Composition for Toner

60.0 parts by weight of the obtained branched polyester and 38.0 parts by weight of the low molecular weight linear polyester were continuously fed to a twin screw extruder (manufactured by Ikegai Corporation, L/D=37) by a metering feeder, and melt kneaded at a barrel temperature of 160° C., and then a volatile fraction was removed from a first venting hole of the twin screw extruder. At this time, the temperature of the branched polyester was 160° C.

Thereafter, the barrel was cooled by flowing cooling water (4° C.) thereinto, to lower the temperature of the branched polyester and the low molecular weight linear polyester immediately before addition of isocyanate to 100° C. 2.0 parts by weight of polymeric MDI containing two or more isocyanate groups in one molecule (44V20, manufactured by Sumika Bayer Urethane Co., Ltd.) was continuously fed from a second venting hole, and further melt kneaded at a barrel temperature of 170° C., thereby obtaining a resin composition for toners.

(4) Preparation of Toner

To 100 parts by weight of the obtained resin composition for toners, 1 part by weight of an electric charge controlling agent (S-34, manufactured by Orient Chemical Industries, Ltd.), 5 parts by weight of carbon black (MA-100, manufactured by Mitsubishi Chemical Corporation), and 3.5 parts by weight of carnauba wax (melting point: 83° C.) were thoroughly mixed using a Henschel mixer, melt kneaded at 130° C., cooled, and coarsely ground. Subsequently, this was finely divided using a jet mill (LABOJET, manufactured by Nippon Pneumatic Mfg. Co., Ltd.) to obtain a toner powder having a mean particle size of about 8 to 12 μm. Further, this toner powder was sieved with a sieving machine (MDS-2: manufactured by Nippon Pneumatic Mfg. Co., Ltd.) to obtain a toner fine powder having a mean particle size of about 10 μm. 100 parts by weight of this toner fine powder was uniformly mixed (treated externally) with 1.0 part by weight of a hydrophobic silica (R972: manufactured by Nippon Aerosil Co., Ltd.) to prepare a toner.

### Comparative Example 7

A resin composition for toners and a toner were prepared in the same manner as in Example 9, except that the branched polyester and the low molecular weight linear polyester, obtained in Example 9, were used, and melt kneaded at a barrel temperature 160° C. in the preparation of the resin composition for toners, and then isocyanate was added without cooling the barrel when the temperature of the branched polyester and the low molecular weight linear polyester was 160° C.

(Evaluation)

Measurement of the molecular weight distribution, the glass transition temperature, the flow softening point, the relaxation modulus, the high temperature offset temperature, and the low temperature offset temperature of the polyester and the resin composition for toners, and the lowest fixation temperature of the toner, as well as evaluation of blocking property, filming, and image quality (fogging observed or not observed, image density) were conducted on the resin composition for toners, or the toner, prepared in each of Example 9 and Comparative Example 7, in the same manner as in Examples 1 and 2, and Comparative Examples 1 and 2. The results are shown in Table 4.

TABLE 4

| | | | | Comparative |
|---|---|---|---|---|
| | | | Example 9 | Example 7 |
| Branched polyester | Amount of raw material | Dimethyl terephthalate | 90 | 90 |
| | monomers to be blended | Dimethyl isophthalate | 5 | 5 |
| | (moles) | Anhydrous phthalic acid | 5 | 5 |
| | | Trimellitic acid | 2.5 | 2.5 |
| | | Neopentyl glycol | 100 | 100 |
| | | Ethylene glycol | 100 | 100 |
| | Evaluation | Glass transition | 52 | 52 |
| | | temperature (° C.) | | |
| | | Weight average | 17000 | 17000 |
| | | molecular weight | | |
| | | Number average | 3100 | 3100 |
| | | molecular weight | | |
| | | Hydroxyl value | 40 | 40 |
| Low molecular weight | Amount of raw material | Dimethyl terephthalate | 90 | 90 |
| linear polyester | monomers to be blended | Dimethyl isophthalate | 10 | 10 |
| | (moles) | Anhydrous trimellitic | — | — |
| | | acid | | |
| | | Neopentyl glycol | 100 | 100 |
| | | Ethylene glycol | 100 | 100 |
| | Evaluation | Glass transition | 54 | 54 |
| | | temperature (° C.) | | |
| | | Weight average | 9400 | 9400 |
| | | molecular weight | | |
| | | Number average | 4900 | 4900 |
| | | molecular weight | | |
| | | Hydroxyl value | 38 | 38 |
| | | Acid value | 2 | 2 |
| Isocyanate compound | Kind | | Polymeric | Polymeric |
| | | | MDI (44V20) | MDI (44V20) |
| | The number of isocyanate groups in one molecule | | about 3 | about 3 |
| The temperature of branched polyester before addition of isocyanate compound (° C.) | | | 100 | 160 |
| Resin composition | Blended amount (parts by | Branched polyester | 60.0 | 60.0 |
| for toner | weight) | Low molecular weight | 38.0 | 38.0 |
| | | linear polyester | | |
| | | Isocyanate compound | 2.0 | 2.0 |
| | Evaluation | Glass transition | 63 | 58 |
| | | temperature (° C.) | | |
| | | Flow softening point | 128 | 119 |
| | | (° C.) | | |
| | | Relaxation modulus | 5.8 × 10² | 1.3 × 10² |
| | | G_{170° C.}(0.1) (Pa) | | |
| toner | Blended amount (parts by | Resin composition for | 100 | 100 |
| | weight) | toner | | |
| | | Carbon black (MA-100) | 5 | 5 |
| | | Electric charge | 1 | 1 |
| | | controlling agent (S-34) | | |
| | | Releasing | 3.5 | 3.5 |
| | | agent | Carnauba | Carnauba |
| | Evaluation | Blocking (% by weight) | 0.5 | 0.5 |
| | | Evaluation of filming | Not | Not |
| | | | observed | observed |
| | | High temperature offset | 230 | 160 |
| | | temperature (° C.) | | |
| | | Low temperature offset | 120 | 120 |
| | | temperature (° C.) | | |
| | | Lowest fixation | 125 | 130 |
| | | temperature (° C.) | | |
| | | Image quality (Fogging | Not | Observed |
| | | observed or not observed) | observed | |

### INDUSTRIAL AVAILABILITY

According to the present invention, a resin composition for toners having excellent low temperature fixability, high temperature offset resistance, and image quality, a toner, and a method for preparing a resin composition for toners can be provided.

### BRIEF DESCRIPTION OF THE DRAWINGS

FIG. 1a is a molecular weight distribution curve of the branched polyester (A) before reaction, obtained by measurement using GPC.

FIG. 1b is a molecular weight distribution curve from each of the resin composition for toners of the present invention, and the branched polyester (A) before reaction, obtained by measurement using GPC.

FIG. 2 is a schematic flow chart showing the relationship between the plunger descent rate and the time (temperature) when a flow softening point, Tf, is determined by a constant-rate temperature elevation method.

FIG. 3 is a schematic diagram for illustrating one example of a kneader used when the method for preparing a resin composition for toners of the present invention is continuously carried out.

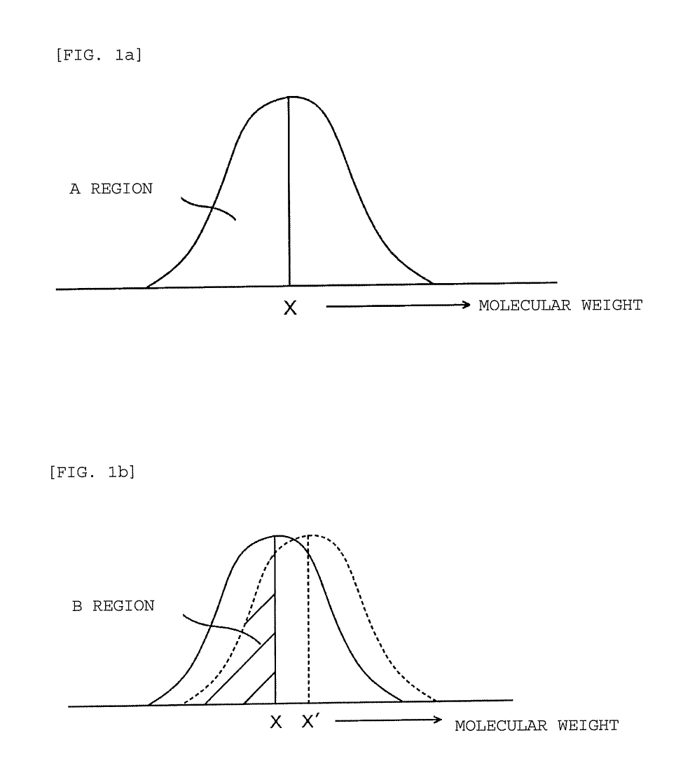

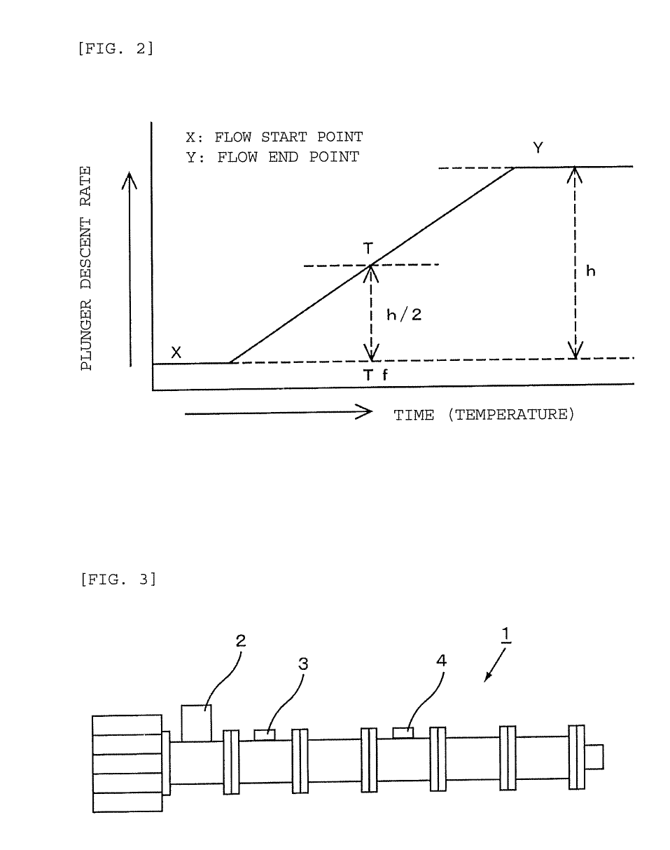

1: Extruding kneader

2: Feed part

3: Opening part

4: Addition part

1. A resin composition for toners, obtained by reacting a mixture of a branched polyester (A) having a number average molecular weight of 2,000 to 7,000 and a hydroxyl value of 20 to 80, and a low molecular weight linear polyester (B) having a number average molecular weight of 2,000 to 5,000 and a hydroxyl value of 20 to 55, with an isocyanate compound containing two or more isocyanate groups in one molecule,
which comprises a crosslinked structure of said branched polyester (A), a structure in which said branched polyester (A) and said low molecular weight linear polyester (B) are bonded by said isocyanate compound, and an unreacted portion of said low molecular weight linear polyester (B).

2. The resin composition for toners as claimed in claim 1, wherein the composition comprises an unreacted portion of the branched polyester having a molecular weight of not more than the peak molecular weight of the branched polyester (A) before reaction, and in the measurement of the molecular weight distribution of a tetrahydrofuran soluble fraction by means of gel permeation chromatography, the peak area in a molecular weight range that is not more than the peak molecular weight of said branched polyester (A) before reaction is in the range of 20 to 45%, based on the total peak area.

3. The resin composition for toners as claimed in claim 1 or 2, wherein the branched polyester (A) has an average branching degree, as represented by the following equation (1), of 2.1 to 7.0:
$$\begin{matrix}[ Equation 1 ] & \\ \begin{matrix}Bu = NOH / N \\ = ( OHV \times {10}^{- 3} / 56.1 ) / ( 1 / Mn ) \\ = OHV \times Mn \times {10}^{- 3} / 56.1\end{matrix} & ( 1 )\end{matrix}$$
wherein Bu represents an average branching degree, NOH represents the number of hydroxyl groups per gram of the branched polyester, N represents the number of molecules per gram of the branched polyester, Mn represents a number average molecular weight, OHV represents the hydroxyl value of the branched polyester, and 56.1 represents the molecular weight of potassium hydroxide.

4. The resin composition for toners as claimed in any one of claims 1, 2, 3, wherein the branched polyester has a water content of 0.1% by weight or less, and the equivalent ratio of the hydroxyl groups to the isocyanate groups in the isocyanate compound is 1 to 28.

5. The resin composition for toners as claimed in any one of claims 1, 2, 3 4, wherein the isocyanate compound contains three or more isocyanate groups in one molecule.

6. A toner comprising the resin composition for toners of any one of claims 1, 2, 3, 4, 5.

7. A method for preparing a resin composition for toners, comprising:
a process 1 in which a branched polyester and a low molecular weight linear polyester are introduced into a kneader equipped with a barrel and a screw, and melted;
a process 2 in which the moisture contained in said branched polyester and low molecular weight linear polyester is removed from the opening of said kneader equipped with the barrel and the screw, to provide said branched polyester and low molecular weight linear polyester with a water content of 0.3% by weight or less; and
a process 3 in which an isocyanate compound containing two or more isocyanate groups in one molecule is added to, and reacted with said branched polyester and low molecular weight linear polyester having the water content of 0.3% by weight or less.

8. The method for preparing a resin composition for toners as claimed in claim 7, wherein in the process 1, the branched polyester and the low molecular weight linear polyester are molten by heating at 120° C. or higher; in the process 2, the molten branched polyester and the low molecular weight linear polyester are controlled to be at 90 to 130° C.; and in the process 3, the isocyanate compound containing two or more isocyanate groups in one molecule is added to said branched polyester and low molecular weight linear polyester that are controlled to be at 90 to 130° C.

9. The method for preparing a resin composition for toners as claimed in claim 7 or 8, wherein the opening part of the kneader equipped with the barrel and the screw is a vacuum venting hole.

10. The method for preparing a resin composition for toners as claimed in any one of claims 7 8, 9, wherein the kneader equipped with the barrel and the screw is a twin screw extruding kneader equipped with a screw having a ratio (L/D) of the length (L) to the diameter (D) of the screw of 30 or more.

11. The method for preparing a resin composition for toners as claimed in any one of claims 7, 8, 9, 10, wherein the kneader equipped with the barrel and the screw has, from an upstream position, a feed part for feeding a branched polyester and a low molecular weight linear polyester, an opening part for removing the moisture contained in said branched polyester and low molecular weight linear polyester, and an addition part for adding the isocyanate compound containing two or more isocyanate groups in one molecule, in this order.
